(19) United States
(12) Patent Application Publication
(10) Pub. No.: US 2025/0343259 A1
(43) Pub. Date: Nov. 6, 2025

(54) Systems of Polymer Binders for Lithium Ion Batteries and Methods Thereof

(71) Applicant: The Regents of the University of California, Oakland, CA (US)

(72) Inventors: Gordon Pace, Goleta, CA (US); My Linh Le, Oakland, CA (US); Rachel Segalman, Oakland, CA (US); Raphaële Clément, Oakland, CA (US)

(73) Assignee: The Regents of the University of California, Oakland, CA (US)

(21) Appl. No.: 19/127,076

(22) PCT Filed: Nov. 6, 2023
(86) PCT No.: PCT/US2023/078843

§ 371 Date: May 2, 2025

Related U.S. Application Data
(60) Provisional application No. 63/382,375, filed on Nov. 4, 2022.
(60) Provisional application No. 63/586,942, filed on Sep. 29, 2023.

(51) Int. Cl. H01M 10/0525; C08K 3/04; H01M 4/02; H01M 4/62; H01M 4/66

(52) U.S. Cl. CPC H01M 10/0525; C08K 3/04; H01M 4/622; H01M 4/668; H01M 2004/028; H01M 2300/0082

(57) ABSTRACT

Systems and methods for polymer binders for battery electrodes are provided. The polymer binders are electrically and ionically conductive, and provide stability and processability as binders. The conductive electrode binders enable improved battery performance.

### CROSS-REFERENCE TO RELATED APPLICATIONS

The current application claims the benefit and priority of U.S. Provisional Patent Application No. 63/382,375 entitled “Systems of Polymer Binders of Lithium Ion Batteries and Methods Thereof” filed Nov. 4, 2022, and U.S. Provisional Patent Application No. 63/586,942 entitled “Systems of Polymer Binders of Lithium Ion Batteries and Methods Thereof” filed Sep. 29, 2023. The disclosures of U.S. Provisional Patent Application Nos. 63/382,375 and 63/586,942 are incorporated by reference in its entirety for all purposes.

### STATEMENT OF FEDERALLY SPONSORED RESEARCH

This invention was made with government support under Grant (or Contract) No. DE-S00016390, awarded by the Department of Energy. The government has certain rights in the invention.

### FIELD OF THE INVENTION

The current disclosure is directed to systems of polymer binders for lithium ion batteries; and more particularly to conductive polymer binders for lithium ion battery cathodes.

### BACKGROUND

Lithium ion battery can include a cathode, an anode and electrolyte as ion conductor. The cathode can include transition metal-based intercalation compounds and the anode can include porous carbon. During discharge, the ions may flow from the anode to the cathode through the electrolyte and separator; charge reverses the direction and the ions flow from the cathode to the anode. The cathodes of lithium ion batteries comprise transition metal-based intercalation compounds as active materials. The active materials are mostly in powder form. Carbon, also in powder form, can be added to the active materials to improve electronic conduction. In order to hold the powdery active materials and/or the carbon additives together, polymer binders can be used in the cathodes. The polymer binders act like a glue to bind the active materials and the additives together. Conventional polymer binders include polyvinylidene fluoride (PVDF), which is electrically insulating.

### BRIEF SUMMARY

Systems and methods in accordance with various embodiments of the invention implement conductive polymer binders in the cathodes of lithium ion batteries. Many embodiments implement polymer binders that can bind cathodes together structurally and also conduct electrons and/or ions. In several embodiments, the polymer binders have various properties including (but not limited to): binding properties (such as binding electrodes active materials and/or additive materials together with current collectors), ionic and electrical conductivity, insolubility in the battery electrolyte, sufficient voltage stability, good processability, and stability over many charging and discharging cycles. The electrically conductive polymer binders in accordance with some embodiments comprise polyelectrolytes with side chains bearing opposite charges (positive charge and negative charge). The electrostatic interactions between the oppositely charged side chains enable the above described properties of the polymer binders in accordance with certain embodiments.

Some embodiments include a polymer binder comprising a conjugated polymer; and a polymer; wherein the conjugated polymer is functionalized with at least a first side chain with a first electrical charge; wherein the polymer is functionalized with at least a second side chain with a second electrical charge that is opposite from the first electrical charge such that an electrostatic interaction is formed between the conjugated polymer and the polymer; and wherein the conjugated polymer and the polymer form the polymer binder via a complexation process and the polymer binder is electrically and ionically conductive.

In some embodiments, the first side chain is balanced with a first counterion, and the second side chain is balanced with a second counterion; the first and the second counterions are released during the complexation process such that the complexation process is thermodynamically favorable.

In some embodiments, the polymer binder is configured to be a portion of a cathode of a lithium ion battery.

In some embodiments, the polymer binder is configured to form a slurry to coat the cathode and connect the cathode with a current collector.

In some embodiments, the cathode comprises an active material selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

In some embodiments, the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

In some embodiments, each of the conjugated polymer and the polymer is at least 50% charged.

In some embodiments, the polymer is a conjugated polymer or a non-conjugated polymer.

In some embodiments, the polymer is selected from the group consisting of: thiophene, propylenedioxythiophene, 3,4-ethylenedioxythiophene, bithiophene, P3HT-Im+, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

In some embodiments, the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

In some embodiments, the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate; wherein the second side chain has a positive charge and comprises a functional group selected from the group consisting of: an amine derivative, imidazolium, ammonium, trimethyl ammonium, triethyl ammonium, and pyridinium.

In some embodiments, the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im+) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

In some embodiments, the polymer binder does not dissolve in a polar electrolyte.

Some embodiments include a cathode, comprising at least one active material; and a polymer binder comprising a conjugated polymer; and a polymer; wherein the conjugated polymer is functionalized with at least a first side chain with a first electrical charge; wherein the polymer is functionalized with at least a second side chain with a second electrical charge that is opposite from the first electrical charge such that an electrostatic interaction is formed between the conjugated polymer and the polymer; and wherein the conjugated polymer and the polymer form the polymer binder via a complexation process and the polymer binder is electrically and ionically conductive.

In some embodiments, the first side chain is balanced with a first counterion, and the second side chain is balanced with a second counterion; the first and the second counterions are released during the complexation process such that the complexation process is thermodynamically favorable.

In some embodiments, the cathode is configured to be a portion of a lithium ion battery.

In some embodiments, the polymer binder is configured to form a slurry to coat the cathode and connect the cathode with a current collector.

In some embodiments, the active material is selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

In some embodiments, the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

In some embodiments, each of the conjugated polymer and the polymer is at least 50% charged.

In some embodiments, the polymer is a conjugated polymer or a non-conjugated polymer.

In some embodiments, the polymer is selected from the group consisting of: thiophene, propylenedioxythiophene, 3,4-ethylenedioxythiophene, bithiophene, P3HT-Im+, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

In some embodiments, the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

In some embodiments, the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate; wherein the second side chain has a positive charge and comprises a functional group selected from the group consisting of: an amine derivative, imidazolium, ammonium, trimethyl ammonium, triethyl ammonium, and pyridinium.

In some embodiments, the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im+) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

In some embodiments, the polymer binder does not dissolve in a polar electrolyte.

Some embodiments further comprise a conductive carbon additive material.

Some embodiments include a lithium ion battery, comprising a cathode comprising an active material; and a polymer binder comprising a conjugated polymer; and a polymer; wherein the conjugated polymer is functionalized with at least a first side chain with a first electrical charge; wherein the polymer is functionalized with at least a second side chain with a second electrical charge that is opposite from the first electrical charge such that an electrostatic interaction is formed between the conjugated polymer and the polymer; and wherein the conjugated polymer and the polymer form the polymer binder via a complexation process and the polymer binder is electrically and ionically conductive; an anode; an electrolyte; and at least one current collector, wherein the polymer binder is configured to form a slurry to coat the cathode and connect the cathode with the at least one current collector.

In some embodiments, the first side chain is balanced with a first counterion, and the second side chain is balanced with a second counterion; the first and the second counterions are released during the complexation process such that the complexation process is thermodynamically favorable.

In some embodiments, the active material is selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

In some embodiments, the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

In some embodiments, each of the conjugated polymer and the polymer is at least 50% charged.

In some embodiments, the polymer is a conjugated polymer or a non-conjugated polymer.

In some embodiments, the polymer is selected from the group consisting of: thiophene, propylenedioxythiophene, 3,4-ethylenedioxythiophene, bithiophene, P3HT-Im+, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

In some embodiments, the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

In some embodiments, the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate; wherein the second side chain has a positive charge and comprises a functional group selected from the group consisting of: an amine derivative, imidazolium, ammonium, trimethyl ammonium, triethyl ammonium, and pyridinium.

In some embodiments, the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im+) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

In some embodiments, the polymer binder does not dissolve in a polar electrolyte.

In some embodiments, the cathode further comprises a conductive carbon additive material.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which form part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention. It should be noted that the patent or application file contains at least one drawing executed in color. Copies of this patent or patent application publication with color drawing(s) will be provided by the Office upon request and payment of the necessary fee.

FIG. 1A illustrates the structure of a lithium ion battery in accordance with prior art.

FIG. 1B illustrates a conventional insulating polymer binder in accordance with prior art.

FIG. 1C illustrates a conductive polymer binder in accordance with an embodiment.

FIGS. 2A-2C illustrate chemical structures of various conductive polymers in accordance with prior art.

FIG. 2D illustrates a conductive polymer binder in accordance with an embodiment.

FIG. 3A illustrates chemical structures of two conductive polymer binders in accordance with an embodiment.

FIG. 3B illustrates chemical structures of the components of the polymer complex in accordance with an embodiment.

FIG. 4A illustrates a schematic of the complex coacervation process in accordance with prior art.

FIG. 4B illustrates the solubility of the polymer complex binder in accordance with an embodiment.

FIG. 4C illustrates a single component conducting polymer as a binder in accordance with an embodiment.

FIG. 4D illustrates a polymer complex as a conductive polymer binder in accordance with an embodiment.

FIG. 5 illustrates cyclic voltammograms of the polymer binder in accordance with an embodiment.

FIG. 6 illustrates conductivity of the polymer complex and the single component conducting polymer in accordance with an embodiment.

FIGS. 7A-7D illustrate rate capability for 85:6:9 LFP:Carbon:Binder cells during symmetric galvanostatic charge/discharge in accordance with an embodiment.

FIGS. 8A-8C illustrate rate capability data for 85:15 LFP:Binder cells during symmetric galvanostatic charge/discharge in accordance with an embodiment.

FIGS. 9A-9D illustrate GITT curves, plotted vs lithium content in accordance with an embodiment.

FIGS. 10A-10D illustrate cyclic voltammetry results obtained at various scan rates for LFP:Carbon:Binder (85:6:9 wt. %) composite cathodes.

FIGS. 11A-11D illustrate cycling stability for LFP:Carbon:Binder (85:6:9 wt. %) composite cathodes using the CPC binder or PVDF in accordance with an embodiment.

FIGS. 12A-12H illustrate synthesis schemes in accordance with an embodiment.

FIGS. 13A and 13B illustrate a schematic of the setup used to determine intrinsic ionic transport properties of the complex in accordance with an embodiment.

FIG. 14 illustrates a schematic of the setup used to determine intrinsic electronic transport properties of the complex in accordance with an embodiment.

FIGS. 15A and 15B illustrate ionic conductivity of the neat complex in accordance with an embodiment.

FIG. 16A illustrates Nyquist plot for the ion conducting P3HT-SO₃⁻-co-P3HT complexed with imidazolium functionalized acrylate between two symmetric blocking electrodes in accordance with an embodiment.

FIG. 16B illustrates Nyquist plot for the ion conducting complex P3HT-co-P3HT-Im⁺PSS⁻ between two, symmetric blocking electrodes in accordance with an embodiment.

FIGS. 17A and 17B illustrate ionic conductivity data for the electrolyte swollen polymers in accordance with an embodiment.

FIG. 18 illustrates current decay for the DC polarization in accordance with an embodiment.

FIGS. 19A-19D illustrate Nyquist plots showing the reduction in impedance in accordance with an embodiment.

FIGS. 20A and 20B illustrate rate capability data in accordance with an embodiment.

FIGS. 21A-21F illustrate variable rate data in accordance with an embodiment.

FIGS. 22A-22D illustrate cycle stability data for (85:6:9 wt. %) composite cathodes utilizing a 1M LiTFSI in 1:1 v EC:DMC electrolyte solution in accordance with an embodiment.

FIGS. 23A-23C illustrate conjugated polyelectrolytes in accordance with an embodiment.

FIG. 24 illustrates electronic conductivity of HTFSI doped samples in accordance with an embodiment.

FIGS. 25A-25C illustrate UV-Vis absorbance spectra for the neat CPEs and for their respective complexes with PSS⁻: (A) P3HT-TMA+, (B) P3HT-Im⁺, and (C) P3HT-co-P3HT-Im⁺ in accordance with an embodiment.

FIGS. 26A-26D illustrate ionic conductivity in accordance with an embodiment.

FIG. 27 illustrates current decay for DC polarization study for the complexes in accordance with an embodiment.

FIG. 28 illustrates ionic conductivity values for polymers passively swollen with 1M LiPF₆ in 1:1 v EC:DMC in accordance with an embodiment.

FIGS. 29A-29F illustrate cyclic voltammograms in accordance with an embodiment.

FIG. 30 illustrates Nyquist plots in accordance with an embodiment.

FIGS. 31A-31D illustrate rate capability data in accordance with an embodiment.

FIGS. 32A-32C illustrate rate capability for cells in accordance with an embodiment.

FIGS. 33A-33C illustrate rate capability for carbon-free cells in accordance with an embodiment.

### DETAILED DESCRIPTION

Turning to the drawings, descriptions of conductive polymer binders for lithium ion battery cathodes are provided. Polymer binders provide structural functions in lithium ion battery cathodes. Conventional polymer binders such as polyvinylidene fluoride (PVDF) are chemically stable and mechanically strong, but PVDF is insulating to ions and electrons. PVDF can hold the active materials (for example in powder form) of the electrodes together and assist in adhering the electrodes to the current collectors. The electrically insulating PVDF does not contribute to charge transfer. Many embodiments implement mixed ionically and electrically conductive battery binders that have comparable structural functions as PVDF and improved charge transport kinetics compared to PVDF. The mixed conductive polymer binders in accordance with several embodiments can be applied to various lithium battery cathodes including (but not limited to) lithium cobalt oxide, lithium manganese oxide, lithium iron phosphate, lithium nickel manganese cobalt oxide, lithium ferro-phosphate (LiFePO₄, LFP), nickel manganese cobalt oxides (NMC), and nickel cobalt aluminum oxides (NCA). As can be readily appreciated, the polymer binders can be used with any of a variety of a cathode active material as appropriate to the requirements of specific applications in accordance with various embodiments of the invention. Some embodiments implement electrically conductive conjugated polyelectrolyte complexed with a polyelectrolyte of opposite charge to create a high-solids loading, viscous solution. The complexes of oppositely charged polyelectrolytes have improved processability compared to most electrically conductive polymers. In certain embodiments, ionic crosslinks between the oppositely charged sidechains can prevent dissolution in the polar electrolyte, overcoming an issue faced by ion conducting binders. As a result, the polymer binders in accordance with many embodiments are electrochemically stable and enable better cathode performance compared to conventional PVDF binders. In certain embodiments, the conductive polymer binder in LFP cathodes can at least double the rate at which the cell can be discharged while maintaining usable capacity, when compared to its PVDF counterpart.

In many embodiments, the conductive polymer binders have various properties including (but not limited to) binding properties, electrochemical stability, mechanical stability, processability, and conducting electrons and ions. Polymer binders are an important part of the lithium ion battery cathodes. Important properties of polymer binders include binding properties and stability. The polymer binders should be able to bind the powders to form a single, solid film that adheres to the metal current collector. The polymer binders should be stable in the electrolyte environment of the battery. The stability includes both electrochemical stability and mechanical stability. In terms of the electrochemical stability, the polymer binder should be electrochemically stable within the operation voltage windows of the battery, for example, from about 2 V to 4 V vs Li/Li⁺ for LiFePO₄ batteries. For mechanical stability, the binder should not dissolve in the liquid electrolyte and should not crack and/or fracture over long term cycling. The conductive polymer binders in accordance with several embodiments possess the desired binding properties, desired stability, desired processability, and desired conductivity. In certain embodiments, the conductive polymer binders are easy to form a slurry and bind the cathodes onto the metal current collector. In some embodiments, the polymer binders are ionically and electrically conductive. Conventional binder materials, such as PVDF, are electrical insulators. Many embodiments implement conductive polymer binders to improve the lithium battery performances.

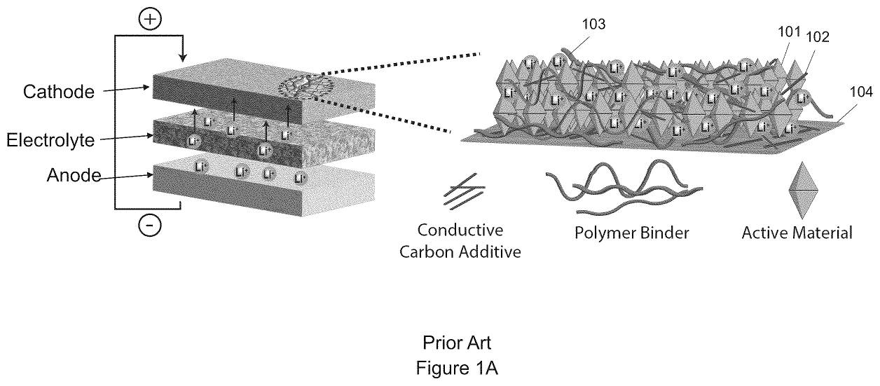

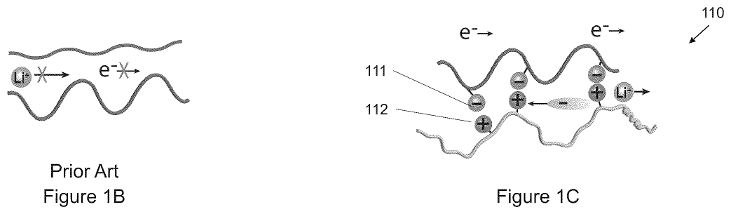

FIG. 1A illustrates the structure of a lithium ion battery. The lithium ion battery includes a cathode, an anode, and an electrolyte. Metal current collector, such as aluminum current collector, can be used to connect the cathode and the anode. FIG. 1A shows that the cathode comprises an active material 101 and a conductive carbon additive 102. The polymer binder 103 binds the powder materials together and forms a film adhered to the metal current collector 104. The active material 101 is responsible for redox activity. Conductive additive 102 is responsible for improving electron transport. The polymer binder 103 can bind the active material and the carbon additive together. Conventional binders include resistive plastics such as PVDF. During the charge and discharge process, ion transport occurs between the electrolyte and active material, and electrons flow between the conductive additive and the current collector. Resistive binders can inhibit each functionality by creating barriers to the transport of these charged species.

FIG. 1B illustrates a conventional insulating polymer binder. Conventional polymer binders are electrochemically and mechanically stable in the electrolyte, and provide good binding properties to the cathodes. However, commonly used polymer binders, such as PVDF, are electrically insulating. Neither electrons nor ions (Li⁺) can be transferred via PVDF.

FIG. 1C illustrates a conductive polymer binder in accordance with an embodiment of the invention. In the conductive polymer binder 110, the side chains are modified with oppositely charged groups 111 and 112. The electrostatic interactions between the oppositely charged groups 111 and 112 enable various properties of the binder including (but not limited to) binding properties, stability, processability, and conductivity.

Conjugated (conducting) polymers can serve a structural role for binders and also enhance the conductivity. Previous work has reported organic polymers that conduct both ions and electrons known as mixed ion-electron conductors (MIECs). MIECs can provide the structural properties of traditional binders, and also contribute functionality via ion and electron conduction. Previous work has shown that using conducting polymers as binders can improve battery performance. However, practical issues such as stability, processability, and solubility limit their widespread adoption.

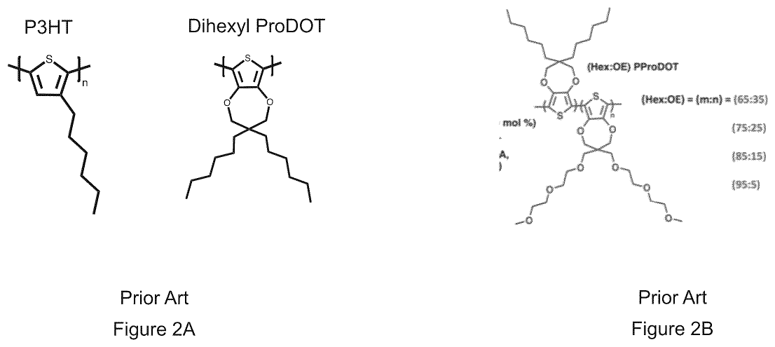

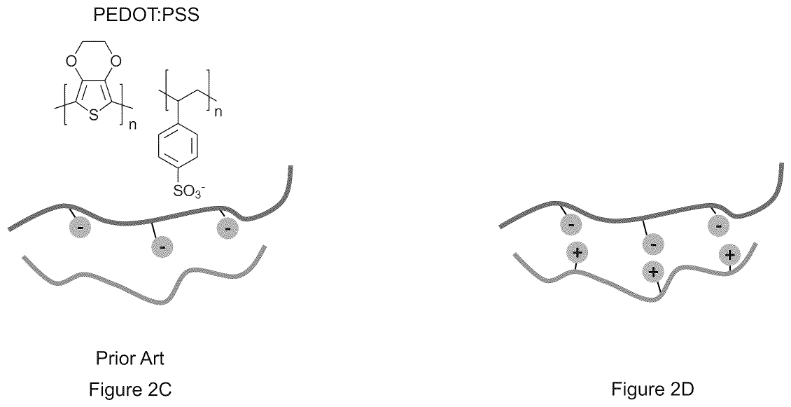

Previous work has used conductive polymer such as poly(3-hexylthiophene-2,5-diyl) (P3HT) and dihexyl-substituted poly(3,4-propylenedioxythiophene) (dihexyl ProDOT) as binders for lithium ion batteries. (See, e.g., C. H. Lai, et al., Chem. Mater., 2018, 30, 2589-2599; P. Das, et al., Chem. Mater., 2020, 32, 9176-9189; the disclosures of which are herein incorporated by references.) Both polymers have alkyl substituted sidechains. P3HT or PProDOT-Hx₂ do not have polar sidechains. Although P3HT and dihexyl ProDOT can conduct electrons, they have negligible ionic conduction. In addition, the polymers are hard to process, costly, and rely on long chain lengths for their mechanical properties. FIG. 2A illustrates chemical structures of P3HT and dihexyl ProDOT.

Incorporating ionic conduction into semiconducting polymers has been studied on the fundamental level, and the application of these systems as battery binders has been reported as a proof of concept. Previous work has shown that adding polar sidechains to polymer binders can improve processability and ionic conduction, such as modifying poly(3,4-propylenedioxythiophenes) with oligoether side chains ((Hex:OE) PProDOT). (See, e.g., P. Das, et al., Chem Mater., 2022, 34, 6, 2672-2686; the disclosure of which is herein incorporated by reference.) However, (Hex:OE) PProDOT has stability issues. The polar sidechains attached to (Hex:OE) PProDOT make it dissolve easily in the polar battery electrolytes. Incorporation of 50% or more of OE relative to hexyl side chains can result in dissolution of the polymer in battery electrolytes and therefore may be unsuitable as polymer binders. In addition, the polymer can dissolve during battery cycling. FIG. 2B illustrates the chemical structure of (Hex:OE) PProDOT. In comparison, the conductive polymer binders in accordance with many embodiments are stable in the electrolyte and during battery cycles. Several embodiments use conjugated polyelectrolytes via complexation such that the ion solvating groups are incorporated in the polymer system without dissolving. Complexation is the combination of individual atom groups, ions, and/or molecules to create one large ion or molecule. A complex can be a chemical compound comprising a central atom or ion, and a surrounding array of bound molecules or ions.

Conducting polymer poly(3,4-ethylenedioxythiophene) polystyrene sulfonate (PEDOT:PSS) has been used as a binder for lithium battery cathodes. (See, e.g., P. R. Das, et al., Journal of the Electrochemical Society, 2015, 162, 4, A674-A678; the disclosure of which is herein incorporated by reference.) Although PEDOT:PSS is a two-component system, PEDOT has no charged sidechains. PEDOT can be doped to have a charge on the backbone to electrostatically interact with the negatively charged SO₃⁻ to form the complex PEDOT:PSS. As not every unit in PEDOT is doped, PEDOT:PSS is not perfectly balanced. The backbone can be undoped so as to lose the charge. Thus, the blend of PEDOT:PSS can be unstable with difficult reproducibility batch to batch. In addition, PEDOT:PSS solution is a particle suspension, which can make processing difficult. FIG. 2C illustrates the chemical structure of PEDOT:PSS. As can be seen in FIG. 2C, PEDOT:PSS does not have side chains. As only the SO₃⁻ groups are negatively charged, there are no electrostatic interactions between sidechains. A P3HT-Poly(ethylene oxide) (PEO) block co-polymer was reported as a conducting battery binder. The PEO block is an uncharged polymer that dissolves salts and is physically immiscible with the conjugated portion of the polymer. This system relies on self-assembly of separate ion/electron domains for mixed conduction and therefore has decreased overall conductivity (comprised only of the volume dedicated to ion or electrons).

FIG. 2D illustrates a conductive polymer binder in accordance with an embodiment of the invention. The conductive polymer binder has both positively charged and negatively charged sidechains. The oppositely charged groups can stabilize the polymer structure via electrostatic interactions between the sidechains.

Many embodiments implement polymer complexes as binders for battery electrodes. In several embodiments, the polymer complexes comprise a conjugated polymer and a non-conjugated polymer, where the conjugated polymer and the non-conjugated polymer can each be functionalized with charged side chains of opposite charges. In a number of embodiments, the polymer complexes comprise a conjugated polymer (also referred as a polyelectrolyte) and a non-conjugated polymer, where the conjugated polymers can be functionalized with oppositely charged side chains from the non-conjugated polymers. In certain embodiments, the conjugated polymer of the polymer complex can be functionalized with positively charged side chains, and the non-conjugated polymer of the polymer complex can be functionalized with negatively charged side chains. In some embodiments, the conjugated polymer of the polymer complex can be functionalized with negatively charged side chains, and the non-conjugated polymer of the polymer complex can be functionalized with positively charged side chains. In several embodiments, the conjugated polymer of the polymer complex can be functionalized with positively charged side chains, and the second conjugated polymer of the polymer complex can be functionalized with negatively charged side chains. Examples of conjugated polymer backbone include (but are not limited to): thiophene, propylenedioxythiophene, 3,4-ethylenedioxythiophene, bithiophene, poly(3-(6′-(N-methylimidazolium) hexyl)thiophene, poly[6-(thiophen-3-yl)hexane-1-sulfonate-co-3-(hexylthiophene)], and poly(3-(6′-(trimethylammonium)hexyl)thiophene. Examples of non-conjugated polymers include (but are not limited to) styrene, acrylate, allyl glycidyl ether, siloxane. Examples of positively charged groups include (but are not limited to): an amine derivative, imidazolium, ammonium, trimethyl ammonium, triethyl ammonium, and pyridinium. Examples of negatively charged groups include (but are not limited to): sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate. In this disclosure, -sulfonyl imide also refers to-sulfonimide, or-sulfonamide, or-sulfonyl amide. Cationic conjugated polymers can be balanced with various counterions and can have charges from about 50% to about 90%; or greater than about 90%. Examples of cationic conjugated polymers (or polyelectrolytes) include (but are not limited to): poly(3-(6′-(N-methylimidazolium)hexyl)thiophene (P3HT-Im+), poly[6-(thiophen-3-yl)hexane-1-sulfonate-co-3-(hexylthiophene)], 90% charged (P3HT-SO₃⁻-co-P3HT, 90% charged), and poly(3-(6′-(trimethylammonium)hexyl)thiophene (P3HT-TMA+), poly(3-(6′-(N-methylimidazolium)hexyl)thiophene Br⁻) (P3HT-Im⁺Br⁻), poly(3-(hexylthiophene)-co-3-(6′-(N-methylimidazolium)hexyl)thiophene Br⁻) 50:50 (P3HT-co-P3HT-Im⁺Br⁻), and poly(3-(6′-trimethylammonium)hexyl)thiophene Br⁻) (P3HT-TMA⁺Br⁻). Examples of anionic polymers (or polyelectrolytes) include (but are not limited to) polystyrene sulfonate (PSS⁻), sulfonate containing poly(sodium 4-styrenesulfonate) (Na⁺PSS⁻), and poly[(3-methyl-1-propylimidazolylacrylamide)-co-3-methyl-1-(propylacrylamide)], 90% charged (imidazolium functionalized acrylate). Examples of conductive polymer complex binders can be a complex of a cationic conjugated polyelectrolyte and an anionic polyelectrolyte such as (but not limited to) P3HT-Im+ and PSS⁻, P3HT-co-P3HT-Im+ and PSS⁻, P3HT-TMA+ and PSS⁻, (PTHS:P3HT) (90:10) complexed with propyl acrylamide, and P3HT-SO₃⁻-co-P3HT and imidazolium functionalized acrylate. As can be readily appreciated, any of a variety of conjugated polymers, non-conjugated polymers, charged functional groups, and polymer complexes can be utilized as conductive polymer binders as appropriated to the requirements of specific applications in accordance with various embodiments of the invention.

In several embodiments, the oppositely charged functional groups on the sidechains of the conjugated polymer and the non-conjugated polymer (or the second conjugated polymers) can interact with each other electrostatically. The interaction between the opposite charges on the conjugated and the non-conjugated polymers (or the second conjugated polymers) can have several advantages. First, the electrostatic interaction may prevent the polymer binder from dissolving in battery electrolyte. Second, the interaction can provide long term cycle stability for the binder. Thirdly, the interaction between the oppositely charged groups has the ability to solvate and transport ions. Lastly, the interaction provides better processability of the binder compared to single component conjugated (electron conducting) polymers.

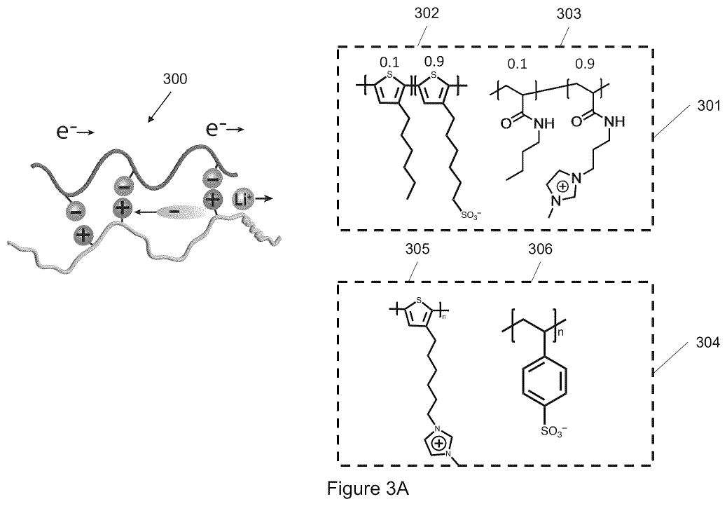

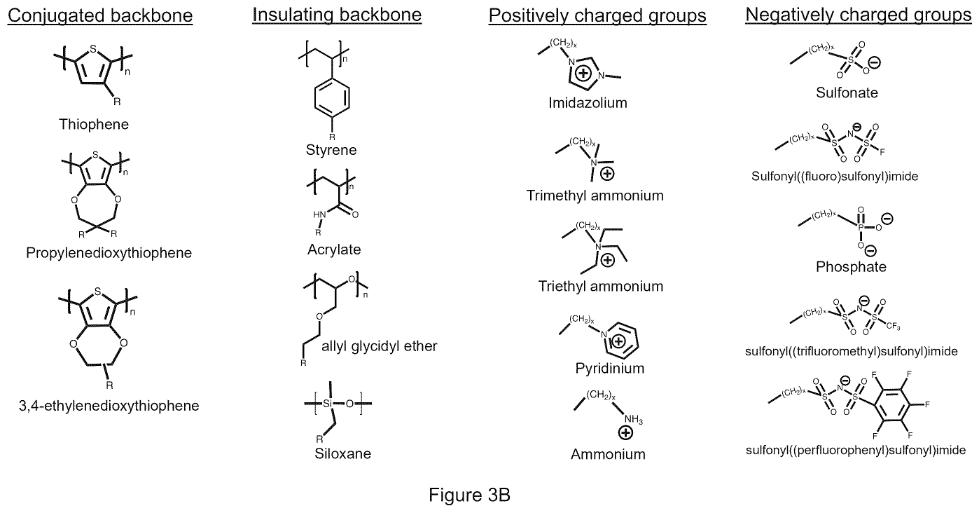

FIG. 3A illustrates chemical structures of two conductive polymer binders in accordance with an embodiment of the invention. Each conductive polymer binder comprises a conjugated (electron conducting) polymer and an insulating polymer of opposite charge 300. A first polymer binder 301 includes conjugated (electron conducting) polymer of P3HT-SO₃⁻-co-P3HT 302 and an insulating polymer of imidazolium functionalized acrylate 303. The conjugated polymer P3HT-SO₃⁻-co-P3HT 302 has a negatively charged side chain, and is 90% charged. The insulating polymer imidazolium functionalized acrylate 303 has a positively charged side chain, and is 90% charged. The anionic conjugated polyelectrolyte (CPE) is complexed with a cationic polymeric ionic liquid (PIL) to form a CPE-PIL Complex (CPC). CPC is also referred as conjugated polyelectrolyte complexes.

A second polymer binder 304 includes conjugated (electron conducting) polymer of P3HT-Im+ 305 and an insulating polymer of PSS⁻ 306. The conjugated polymer P3HT-Im+ 305 has a positively charged side chain. The insulating polymer PSS⁻ 306 has a negatively charged side chain.

Many embodiments implement polymer complexes comprising at least one conjugated polymer. The conjugated polymer can be complexed with a conjugated polymer or a non-conjugated polymer. The two polymer components of the complex can be functionalized with oppositely charged side chains. The side chains can include any numbers of carbon or can be carbon free. The side chains can be of any length that is appropriate to the polymer complex in accordance with several embodiments. In various embodiments, the side chains can be about 100% charged; or about 90% charged; or less than about 90% charged; or about 50% charged. FIG. 3B illustrates chemical structures of the components of the polymer complex in accordance with an embodiment of the invention. Examples of conjugated polymer backbone include (but are not limited to): thiophene, propylenedioxythiophene, and 3,4-ethylenedioxythiophene. As can be readily appreciated, any of a variety of a conjugated polymer can be utilized as appropriate to the requirements of specific applications in accordance with various embodiments of the invention. Examples of non-conjugated (or insulating) polymer backbone include (but are not limited to): styrene, acrylate, allyl glycidyl ether, and siloxane. As can be readily appreciated, any of a variety of a non-conjugated polymer can be utilized as appropriate to the requirements of specific applications in accordance with various embodiments of the invention. Examples of positively charged groups include (but are not limited to): imidazolium, trimethyl ammonium, triethyl ammonium, pyridinium, and ammonium. As can be readily appreciated, any of a variety of a positively charged functional group can be utilized as appropriate to the requirements of specific applications in accordance with various embodiments of the invention. Examples of negatively charged groups include (but are not limited to): sulfonate, sulfonyl((fluoro)sulfonyl)imide, phosphate, sulfonyl((trifluoromethyl)sulfonyl)imide, and sulfonyl((perfluorophenyl)sulfonyl)imide. As can be readily appreciated, any of a variety of a negatively charged functional group can be utilized as appropriate to the requirements of specific applications in accordance with various embodiments of the invention.

### Lithium Ferro-Phosphate Cathodes

Lithium ion batteries can be used in electric vehicles and large-scale stationary storage implementations. The lithium ion battery includes two main chemistry classes: 1) layered transition metal oxides (LiMO₂, with M=Ni, Mn, Al, and/or Co, abbreviated NMC and NCA); and 2) phospho-olivines, such as LiFePO₄ (LFP). These materials are orthogonal in most metrics-performance, cost, and ethics. NMC and NCA cathodes may have high energy due to their high specific capacity and average voltage. However, they are burdened with high financial and ethical cost due to the reliance on cobalt and to a lesser extent nickel).

LFP is an attractive alternative due to its inexpensive material composition and reasonable theoretical capacity of about 170 mAh/g and redox potential (about 3.5V vs Li/Li+). However, practical performance issues may limit its applications. The poor performance issues may be due to the poor electrical conductivity and lithium diffusion of LFP. These performance limitations can reduce the rate capability of the material, which in turn limit its practical power output. Modifications such as carbon coatings and reducing LFP particle sizes have made improvements, yet these do not sufficiently address the issue and have practical limitations. For example, smaller particles have more total surface area, requiring more carbon additive for electrical connectivity and more binder to keep the particles together, which limits the cells energy density and performance. (See, e.g., D. Y. W. Yu, et al., J Electrochem Soc, 2007, 154, A253; the disclosure of which is herein incorporated by reference.)

One way to enable high rate capability in cobalt free cathodes may be the modification of the polymer binder. Cathodes are composites where a mix of various materials working in tandem to provide the overall functionality of the electrode. The active material (LFP, NCA, NMC, etc.) may comprise the bulk of the electrode (about 80%-95% by mass), with the remainder being carbon additives for electrical conductivity and a polymer binder to hold the components together. While binding is a necessary function, the issue lies in the fact that the cathode binder, polyvinylidene fluoride (PVDF), is an insulator to both ionic and electrical current.

Many embodiments implement a mixed-conducting polymer binder complex in LFP cathodes. The binder complex can improve performances in LFP cathodes. Electrostatic-mediated coacervation between the two oppositely charged polyelectrolytes results in a formation of a highly viscous gel, improving processability. Additionally, the electrostatic attractions between oppositely charged pendant side chains serve as ionic crosslinkers, reducing the influence of molecular weight and dispersity on macroscopic properties. For example, single component polymers rely on the entanglement of long chains for their mechanical properties. Specifically, short chain polymers have different solubility than long chain polymers. In several embodiments, the ionic cross links in the conductive polymer binders can prevent dissolution of the complex in the battery electrolyte. In certain embodiments, complexation with the polymeric ionic liquid (PIL) can improve the conjugation length of the conjugated polymer, leading to at least 3-order of magnitude improvement in the electronic conductivity of the system from about 0.001 S/cm to about 1 S/cm compared to the single component conjugated polymer. Several embodiments implement functional cells in the absences of carbon conductive additive, which shows conductivity of the binder given the poor electronic conductivity of LFP.

Complexation also provides advantageous physical properties, namely preventing dissolution in the battery electrolyte while also maintaining processability during slurry casting. Each polyelectrolyte taken by itself is soluble in the battery electrolyte, but after complexation and drying, the CPC proves insoluble due to the ionic crosslinks. This solves a major hurdle faced by many multifunctional polymer binders, where improvements in ionic conductivity also lead to greater solubility in battery electrolytes because the highly polar or charged groups capable of transporting ions dissolve in the highly polar electrolyte solution. Prior to drying, this CPC chemistry affords the formation of a coacervate phase, which is important for applying CPCs as binders. The precipitate phase contains polymer dense, irregular solids with very low solvent content, preventing a uniform coating of the cathode powders. A single-phase solution may enable uniform coating and slurry casting. However, each polyelectrolyte would still contain its respective counterion (tetramethylammonium and Cl⁻ in this system), which could interfere with battery operation by competing with Li⁺ transport. Coacervation involves a counterion release into the supernatant phase (the entropic gains of which are a driving force for the coacervate phase formation), and subsequent rinsing can remove residual ions. Finally, the isolated coacervate phase remains processable, maintaining the ability to flow and form uniform coatings.

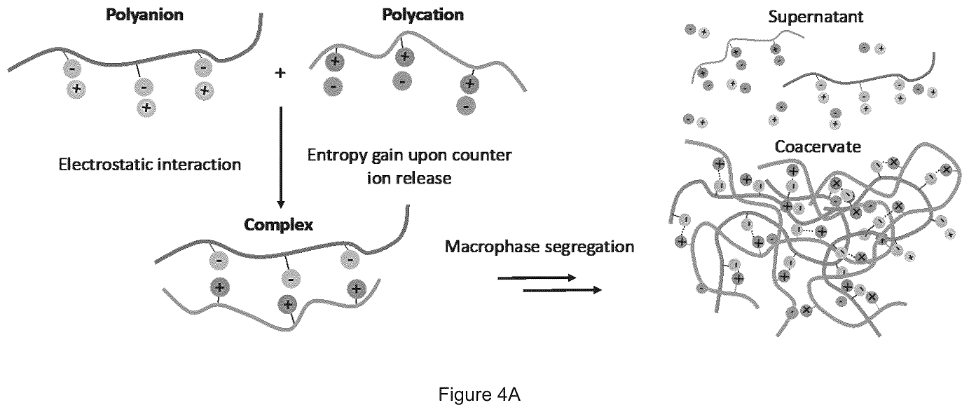

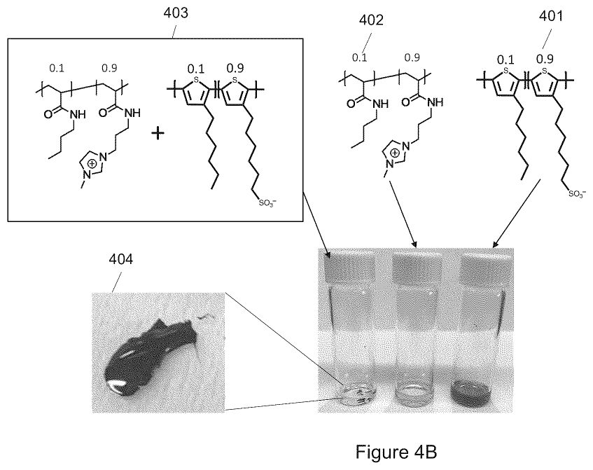

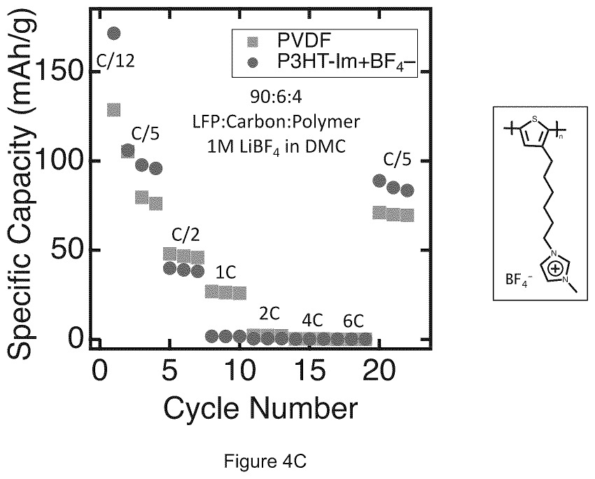

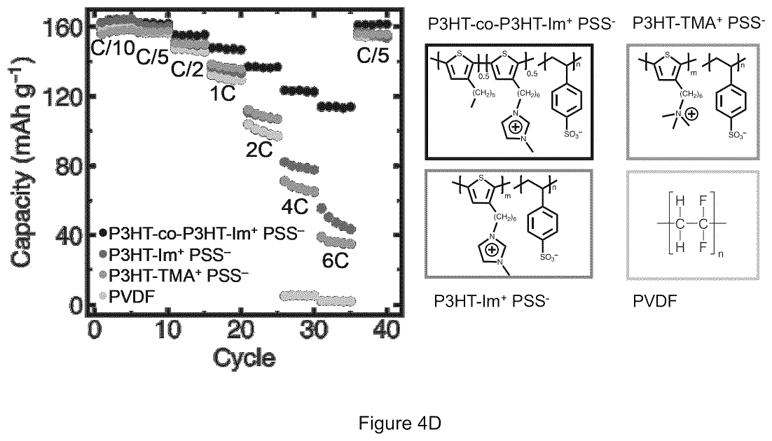

FIG. 4A illustrates a schematic of the complex coacervation process. When a polyanion and polycation are mixed, the electrostatic interactions and entropy gains of counterion release drive complexation. This typically results in macro-phase separation, and when solvent quality is properly tuned (i.e. 40/60 THF/water v/v), a polymer rich coacervate phase is in equilibrium with a polymer dilute, counterion rich supernatant phase. The coacervate phase can be isolate via centrifuge, and further studied.

Many embodiments implement complexing polyelectrolytes to form conductive polymer binders for lithium batteries including (but not limited to) LFP. Complexing two polyelectrolytes with oppositely charged sidechains can provide synergistic effects for the properties necessary for conductive battery binders including (but not limited to) stability, (in)solubility, conductivity, and processability. Electrostatic interactions, along with entropy gains upon the release of the counterions, drive and stabilize the complex. FIG. 4B illustrates the solubility of the polymer complex binder in accordance with an embodiment. In FIG. 4B, the conjugated (electron conducting) polymer of P3HT-SO₃⁻-co-P3HT 401 and the insulating polymer of imidazolium functionalized acrylate 402 is soluble in the battery electrolyte. Battery electrolyte is about 1M LiTFSI in 1:1 v EC:DMC. After complexation and drying, the polymer complex 403 is insoluble in the electrolyte. The complex of the two polyelectrolyte is a viscous, high solids content coacervate 404. The solids formation can be due to the ionic crosslinks. For many multifunctional polymer binders, ionic conductivity of the binder is typically at odds with solubility in the electrolyte (highly polar or charged groups capable of transporting ions will also dissolve in the highly polar battery electrolyte). In comparison, the conductive polymer binder is stable in lithium battery electrolyte.

Several embodiments implement the isolated, dried coacervate phase of the complex in cell testing and performance analysis. Once isolated/dried, this phase may no longer be a coacervate, but rather an electrostatically stabilized complex. The binder can be referred to as a conjugated polyelectrolyte (CPE)-polymeric ionic liquid (PIL) complex (CPC). Forming and isolating a coacervate can benefit processing processes. The final CPC affords ionic conduction via the charged side chains and enhances electronic conductivity due to planarization of the conjugated backbone. Additionally, the final CPC is an ionically crosslinked solid, which will not re-dissolve in the solvent or battery electrolyte. While withstanding electrolyte dissolution is important for battery applications, an intermediate phase for processing may be needed to form an electrode slurry. By tuning polymer concentration and solvent quality, a coacervate can be formed, which is a polymer rich phase that maintains the ability to flow, swell with solvent, and form coatings prior to drying. Through this liquid-liquid phase separation, the bulk of the polymer is concentrated in the coacervate phase, while the bulk on the counterions and dilute polymer are in the supernatant phase. Coacervation is an effective process to drive miscibility to two distinct polymers to generate a system with enhanced stability and conductivity, while maintaining intermediate processability.

Several embodiments provide that single component conducting polymer may create poorly formed electrode and may require a change to the electrolyte. FIG. 4C illustrates a single component conducting polymer as a binder in accordance with an embodiment. A single component conducting polymer P3HT-Im+ can be balanced with BF₄⁻. The single component polymer binder can be dissolved in EC:DMC electrolyte. As shown in FIG. 4C, the single component conducting polymer has a lower capacity compared to a conventional PVDF binder in lithium battery. The single component polymer binder has poor adhesion to the current collector, and the polymer flakes off due to poor processability. FIG. 4D illustrates a polymer complex as a conductive polymer binder in accordance with an embodiment. Rate capability data shows a variety of polymer chemistries (P3HT-co-P3HT-Im+ complexed with PSS⁻, P3HT-Im+ complexed with PSS⁻, P3HT-TMA+ complexed with PSS⁻) provide superior rate capability when applied as binders, as compared to PVDF. The polymer binder shows stability and does not dissolve in the 1M LiPF₆ in EC:DMC electrolyte. Cells utilize LFP:Carbon:Binder at a 85:6:9 wt % formulation.

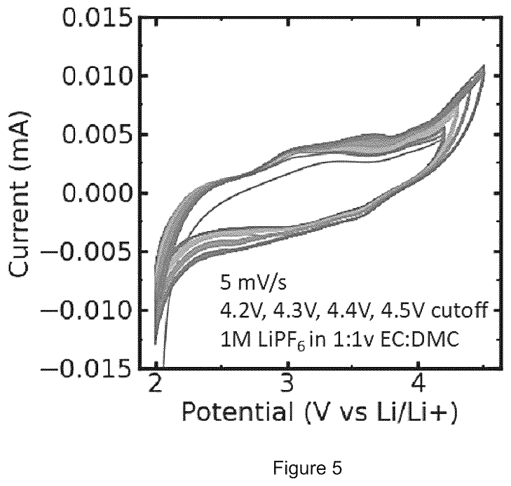

FIG. 5 shows cyclic voltammograms of the polymer binder in accordance with an embodiment. The cyclic voltammetry is carried out to the polymer complex (P3HT-Im+ complexed with PSS⁻) in standard battery electrolyte, with 5 scans at different upper potential limits up to about 4.5 V. As can be seen, each curve overlaps well, which indicates there is no dissolution in electrolyte or electrochemical dissolution. The complex contains a conjugated polymer, and thus it should have reversible redox peaks between 3.2 and 4V vs Li/Li⁺. In FIG. 5, the complex is blade coated directly onto aluminum foil, dried at about 110° C. and 2×10⁻⁸ torr, and then loaded into coin cells (details in the Examples sections below), where the complex serves as the working electrode and lithium metal serves as the counter/reference electrode. The good overlap of the CV curves obtained for each cycle indicates the stability of the CPC up to 4.5V.

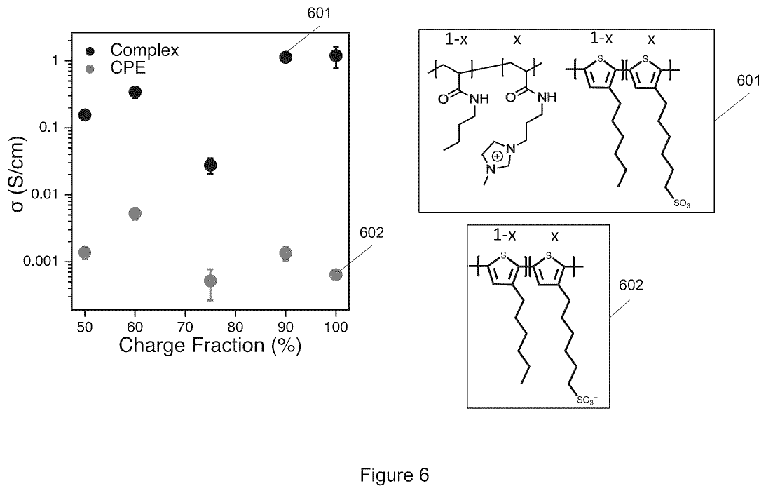

FIG. 6 illustrates conductivity of the polymer complex and the single component conducting polymer in accordance with an embodiment. Complexation also increases the electrical conductivity of the polymer complex from about 0.001 S/cm to about 1 S/cm. The complex 601 (P3HT-SO₃⁻-co-P3HT complexed with imidazolium functionalized acrylate) has higher conductivity than the single component conducting polymer (CPE) 602 (P3HT-SO₃⁻-co-P3HT). Additionally, the system is electrochemically stable up to 4.5V vs Li/Li+. Finally, the complex forms a viscous coacervate phase, enabling slurry coating of electrodes.

Polyelectrolytes in accordance with some embodiments can be chosen to maximize conductivity while enable coacervation and electrochemical stability. Thiophene backbones have narrow band gap and synthetic tunability via side chain functionalization. Thiophene backbones can also be semiconducting where the thiophene are insulators until oxidization occurs around 3.2 V vs Li/Li+. The properties of thiophene are suitable for LFP cathodes, as the flat (dis)charge voltage profile characteristic of LFP's two phase reaction occurs above the thiophene oxidization potential (around 3.4-3.2 V). In the voltage range between about 3.4 V and about 3.2 V, the polymer binder can be conductive during the duration of charge and discharge, but will transition to insulating below 3.2 V, which may offer protection against over discharge. The PIL can be an acrylate functionalized with an imidazolium side chain, as this group has a wide electrochemical stability window, as well as favorable ionic transport properties owing to its diffuse charge.

### Rate Performance

Some embodiments implement 2032-coin cells using lithium metal as the anode/reference electrode and commercially available LiFePO₄ (LFP) as the cathode active material. Standard cathode construction can utilize the active material in conjunction with a carbon additive to enhance electronic conductivity, and a polymer binder to hold everything together. Cathodes can be made with about 85% LFP, about 6% carbon black, and about 9% binder (all mass percent). The binder can be the polymer complex (P3HT-SO₃⁻-co-P3HT complexed with imidazolium functionalized acrylate) or PVDF. Certain embodiments implement carbon black free cells, replacing the carbon content with additional binder (85:15 LFP:binder) to more directly evaluate the ability of the conducting binder to provide long range conductivity.

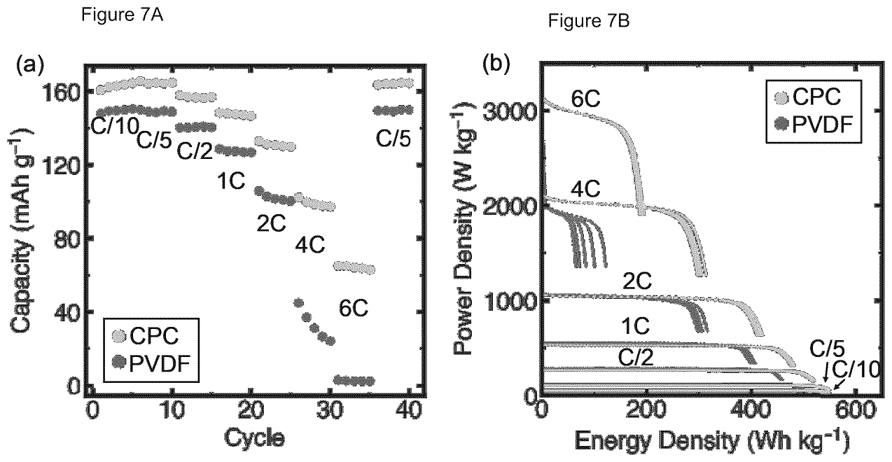

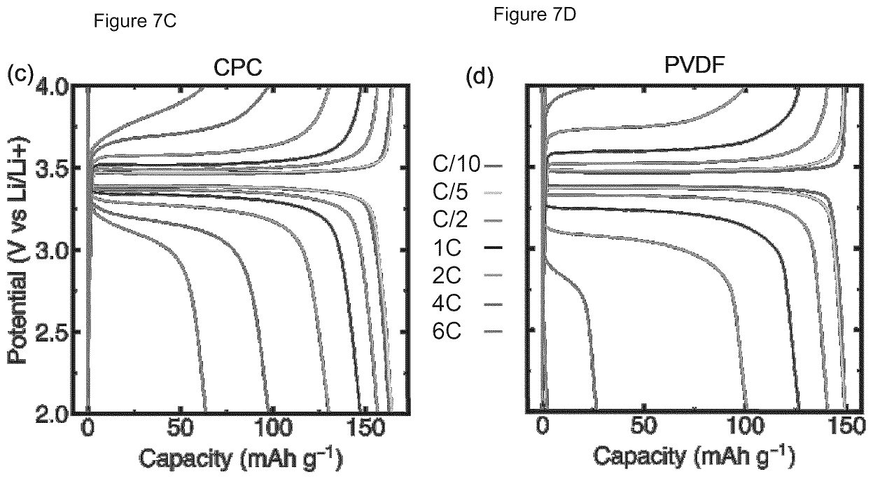

The complex binder in accordance with many embodiments enable higher utilization and rate performance. A “C rate” is a standard way to indicate how fast the battery is being charged or discharged. 1 C can be referred as (dis)charge the entire battery in about 1 hour. C/2, is half that rate, meaning the capacity is utilized in 2 hours. C/10 can be referred as (dis)charge may take 10 hours. 6 C can be referred as (dis)charge may take 10 minutes. C rates can be set using a theoretical capacity, for example about 170 mAh/g for the polymer complex. FIGS. 7A-7D show rate capability for 85:6:9 LFP:Carbon:Binder cells during symmetric galvanostatic charge/discharge in accordance with an embodiment. Symmetric galvanostatic charge and discharge cycles can be performed for 5 cycles each at rates between about C/10 and about 6 C, as shown in FIG. 7A. While the complex binder enables higher utilization, the slow rate performance is similar between the cells. At high rates (4 C and 6 C), a big difference can be seen between the complex and PVDF containing cells as shown in FIG. 7A. The complex enables a much higher discharge capacity, achieving about 102 mAh/g at 4 C compared to about 44 mAh/g for PVDF. At 6 C the CPC (P3HT-SO₃⁻-co-P3HT complexed with imidazolium functionalized acrylate) achieves about 65 mAh/g, while the PVDF cell only achieves about 2 mAh/g—effectively no capacity. Both binders prove stable through high rate cycling, fully recovering the slow rate capacity during the final C/5 cycles.

The high rate capability of the CPC (P3HT-SO₃⁻-co-P3HT complexed with imidazolium functionalized acrylate) is consistent with the reduced polarization observed in FIG. 7C and FIG. 7D, indicating the complex binder improves charge transport kinetics within the electrode. Cell polarization is a form of electrochemical hysteresis (also called dissipative hysteresis) that results from sluggish kinetic processes as opposed to other thermodynamic mechanisms of hysteresis, including first-order phase transitions, displacement and conversion reactions, reaction path hysteresis, etc. Polarization leads to an overpotential, i.e., a deviation of the potential from the true equilibrium potential of the redox reaction. Li extraction from LFP on charge, Li reinsertion into LFP on discharge, and therefore to a voltage hysteresis between the charge and discharge processes. Polarization refers to the excess or lack of potential at equilibrium. Each element within the battery undergoes charge transfer at a different rate, the slowest of which is the rate limiting process. Due to this, the actual potential can be larger (charge) or smaller (discharge) than the equilibrium value. This difference is referred to as overpotential, which measures the extent of polarization. From the galvanostatic charge/discharge voltage profiles shown in FIG. 7C and FIG. 7D, at slow rates (C/10 and C/5) the polarization is rather similar between CPC and PVDF cells, indicating charge transfer through the binder may not be a rate limiting step. However, at higher rates, smaller overpotentials in both charge and discharge cycles can be observed for cells with the complex binder compared to the PVDF cell. For example, at 2 C the PVDF cell's nominal charge potential occurs around 3.77 V and its discharge potential at about 2.97 V, while those of the complex are about 3.61 V and about 3.16 V respectively. Since the binder is the only variable between cells, this indicates that at high rates, the resistivity of PVDF is a key limiter to charge transfer.

The reduced polarization and enhanced capacity at high discharge rates is important, as it determines the usable power output and energy density. By reducing resistive barriers, the conductive binder in accordance with many embodiments enables higher currents and higher discharge potentials, thus increasing the practical power and energy density. The relations for power, current, potential, and time are listed as below:

$$Power = I \times V$$

$$Engery = Power \times t$$

In several embodiments, the complex enables higher currents to be maintained for longer times, manifesting itself via better power/energy (FIG. 7B).

Some embodiments provide lithium battery performances without carbon black additive. Cells containing no carbon black additive further emphasize the ability of the complex binder to provide long range charge transport within the electrode. Typically, two forms of carbon coating are used in composite cathodes. Carbon coating of the active material itself is used to enhance conductivity of the particles, while additives such as carbon black and carbon nanotubes are used for long range interconnectivity of charge transport pathways. In the tests, the active material is LFP coated with about 1.4% by mass carbon. This is used to enhance conductivity of individual particles. To provide long range charge transport, carbon black is added. PVDF inhibits this long-range transport due to its insulating properties, and replacing PVDF with the conductive binder in accordance with embodiments addresses this issue. To better analyze this, additional binder can be used in lieu of carbon black (85:15 LFP:binder, as opposed to 85:6:9 LFP:CB:Binder). In many embodiments, the conductive binder can facilitate long range conductivity.

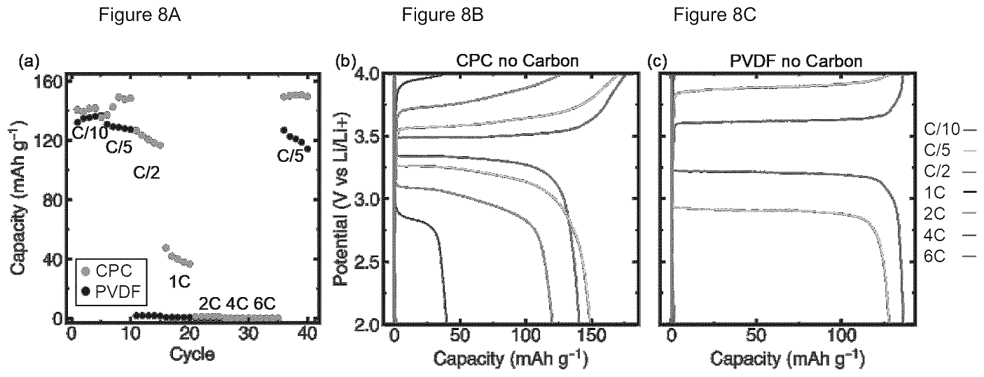

FIGS. 8A-8C illustrate rate capability data for 85:15 LFP:Binder cells during symmetric galvanostatic charge/discharge in accordance with an embodiment. FIG. 8A shows discharge capacity at the indicated current rates. FIG. 8B and FIG. 8C show charge and discharge voltage profiles for the CPC (P3HT-SO₃⁻-co-P3HT complexed with imidazolium functionalized acrylate) without carbon and the PVDF cell without carbon respectively, reported for the 4^{th} cycle at each indicated rate. FIGS. 8A-8C show the carbon free cell utilizing the complex binder performs remarkably better than the PVDF cell. The PVDF cell achieves effectively 0 discharge capacity at rates faster than C/5, whereas the complex cell achieves about 126 mAh/g at C/2 and about 47 mAh/g at 1 C. A dramatic decrease in cell polarization is seen in the complex cells (FIGS. 8B and 8C), emphasizing the improvements to long range conductivity provided by the complex binder.

### Kinetics and Lithium Diffusion

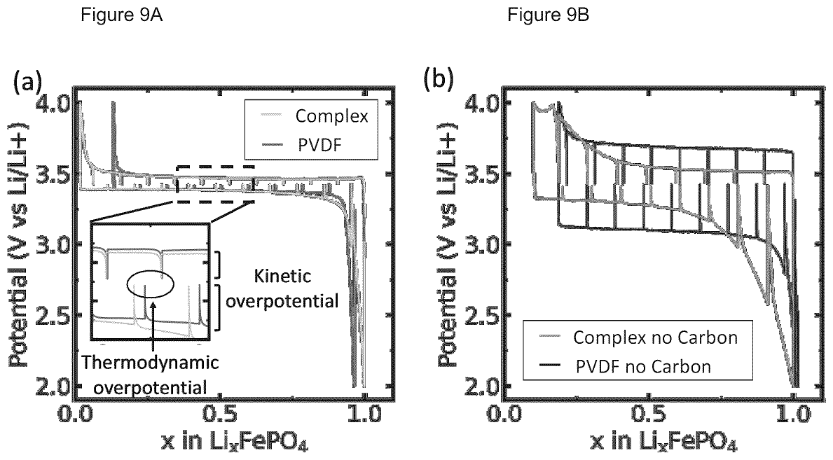

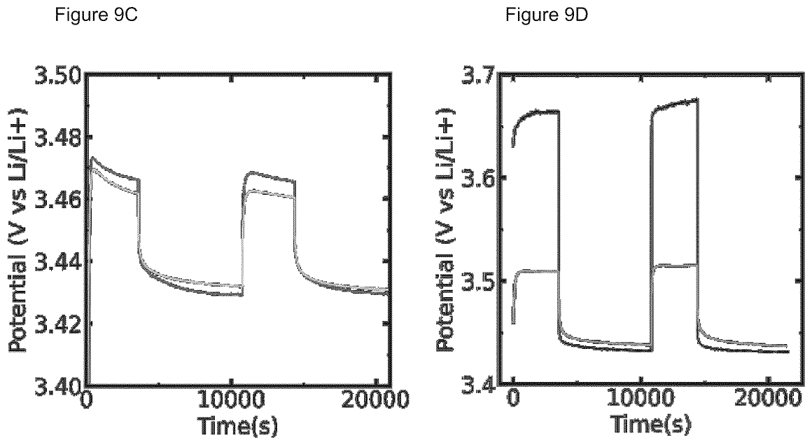

Galvanostatic Intermittent Titration Technique (GITT) shows that the conductive complex binder can reduce charge transport limitations or reduce the kinetic barriers to charge transport during both charge and discharge. GITT is a technique to separate thermodynamic and kinetic overpotential. As mentioned earlier, kinetic overpotentials or polarization result in a dissipative form of voltage hysteresis that can be minimized by systematically reducing the rate with which the battery is charged and discharged. In a GITT experiment, the kinetic overpotential is the difference between the potential during the constant current pulse and the equilibrium potential after a sufficiently long rest period when no current is flowing through the circuit (FIG. 9A). The thermodynamic overpotential depends on the nature of the electrochemical reaction taking place. Thermodynamic overpotential can be derived from the reaction occurring, and is measured via the hysteresis between the discharge and charge equilibrium voltage. Kinetic overpotential can be derived from rate limitations of lithium insertion/extraction, and can be represented by the polarization measured in GITT (the difference between the potential at constant current and the equilibrium potential). Given that all composite cathodes tested here utilize the same LFP active cathode material, the thermodynamic overpotential is expected to be similar for cathode films comprising the CPC binder (P3HT-SO₃⁻-co-P3HT complexed with imidazolium functionalized acrylate) and for those containing PVDF, which is indeed the case. However, a reduced kinetic overpotential is observed for the composite cathodes containing the CPC binder over the potential plateau (at 3.4-3.5 V), signifying faster charge transfer kinetics. The greater capacity recorded for cathodes containing the CPC binder indicate a greater utilization of the LFP cathode: all of the Li can be reversibly extracted from and reinserted into LFP on charge and discharge. In addition to overpotential, it is important to evaluate the point of (de)lithiation are kinetic restrictions limit the capacity. Compared to PVDF, the complex pushes the onset of kinetic limitations to lower lithium content. FIGS. 9A-9D illustrate GITT curves, plotted vs lithium content in accordance with an embodiment. FIG. 9A shows cells containing carbon black and FIG. 9B shows cells without carbon black. The inset in FIG. 9A shows the features of the curve associated with kinetic and thermodynamic overpotentials. FIG. 9C and FIG. 9D show the first two charge steps vs time to better visualize the differences in overpotential.

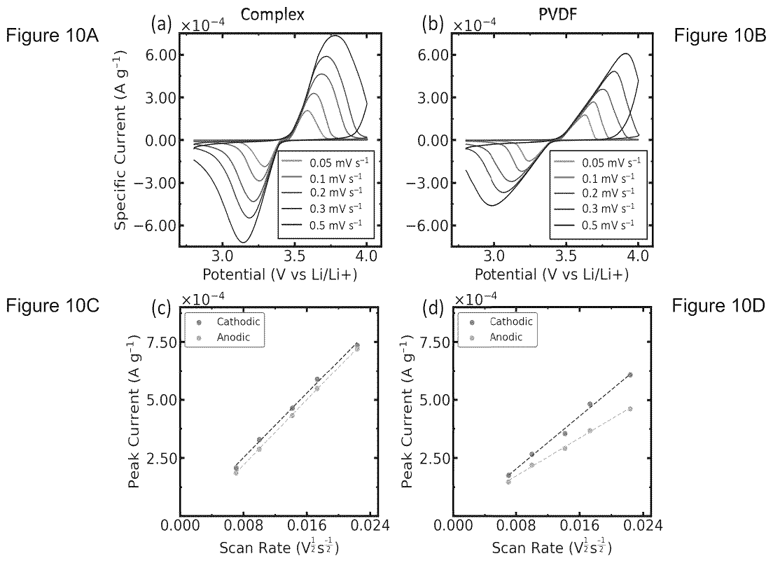

FIGS. 10A-10D illustrate cyclic voltammetry results obtained at various scan rates for LFP:Carbon:Binder (85:6:9 wt. %) composite cathodes. The binder in FIGS. 10A and 10C is CPC (P3HT-SO₃⁻-co-P3HT complexed with imidazolium functionalized acrylate). The binder in FIGS. 10B and 10D is PVDF. The cyclic voltammograms are shown in FIGS. 10A and 10B, and peak currents as a function of the square root of the scan rate in FIGS. 10C and 10D.

Cyclic voltammetry (CV) experiments indicate the complex binder can increase the apparent lithium diffusion coefficient within the cathode (D_{Li+}). CV scans of composite cathodes containing either the CPC binder (P3HT-SO₃⁻-co-P3HT complexed with imidazolium functionalized acrylate) or PVDF are shown in FIGS. 10A and 10B where kinetic limitations manifest themselves as a shift of the anodic and cathodic peaks to lower and higher potentials, respectively, upon increasing the potential scan rate. The smaller shifts observed for the composite cathode utilizing the CPC binder are in line with the smaller overpotentials observed via galvanostatic cycling and GITT. The kinetic differences between the two types of composite cathodes can be quantified via the apparent diffusion coefficient using the Randles-Sevcik equation,

$${I}_{p} = 0.4 \; 463 {n}^{\frac{3}{2}} {F}^{\frac{3}{2}} C S {R}^{\frac{- 1}{2}} {T}^{\frac{- 1}{2}} {D}_{Li +}^{\frac{1}{2}} {v}^{\frac{1}{2}}$$

where Iₚ is the peak current (A), n is the charge transfer number, F is the Faraday's constant (96486 C mol⁻¹), C is the concentration, S is the electrode surface area (cm²), R is the gas constant (8.314 J mol⁻¹ K⁻¹), Tis temperature (K), D_{Li+} is the apparent diffusion coefficient (cm²s⁻¹), and v is the scan rate (V s⁻¹).

Iₚ is plotted as a function of the square root of v^{1/2} to determine D_{Li+} in FIGS. 10C and 10D. Here, D_{Li+} is the apparent lithium diffusion coefficient, representative of the average kinetics of all Li⁺ diffusional processes occurring in the cathode film. Given that the only difference between the composite cathodes is the binder, any variation in D_{Li+} stems from the binder's impact on overall kinetics. As expected, the composite cathode containing the CPC binder (P3HT-SO₃⁻-co-P3HT complexed with imidazolium functionalized acrylate) has higher anodic (charge) and cathodic (discharge) diffusion coefficients (D_{Li+}=7.4×10⁻¹¹ and 7.1×10⁻¹¹ cm²s⁻¹, respectively) compared to PVDF (D_{Li+}=2.4×10⁻¹¹ and 4.8×10⁻¹¹ cm²s⁻¹, respectively). Interestingly, the CPC cathode has nearly overlapping curves for the anodic and cathodic sweeps (FIG. 10C), indicating similar kinetics for lithium extraction from and reinsertion into the LFP composite cathode. The PVDF cell has differing kinetics, where the lithiation process (discharge) is more sluggish, consistent with previous reports. Overall the results from CV, GITT, and rate capability are consistent, where the electronic conductivity, ionic conductivity, and lithium transference afforded by the CPC binder results in superior Li+ mobility, enhanced charge transport kinetics, and ultimately superior rate capability for the composite cathodes.

### Cycle Stability

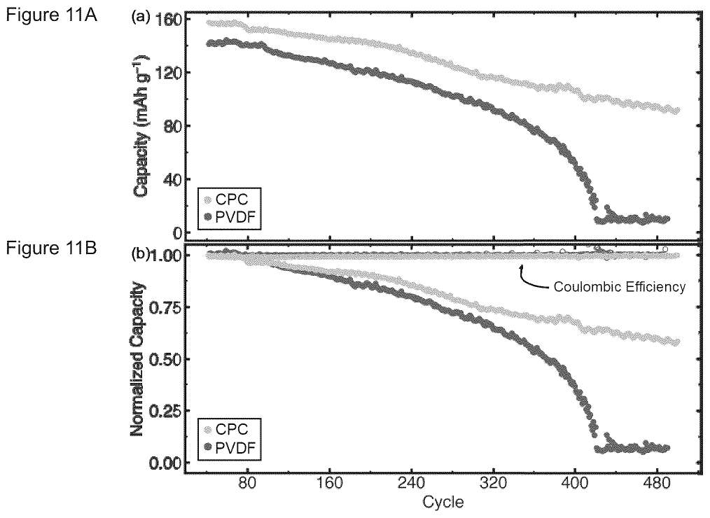

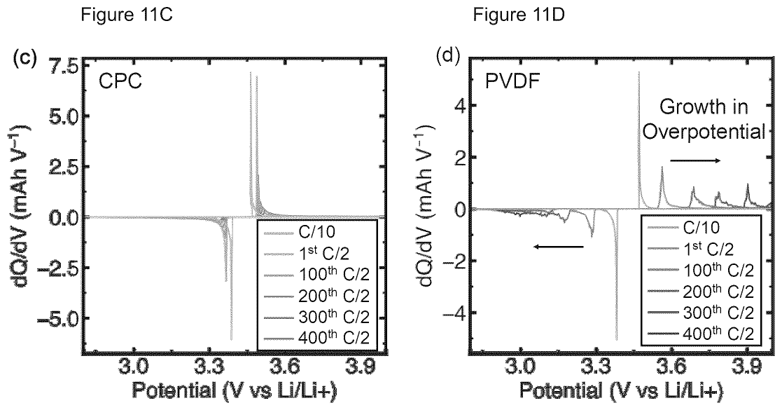

FIGS. 11A-11D illustrate cycling stability for LFP:Carbon:Binder (85:6:9 wt. %) composite cathodes using the CPC binder (P3HT-SO₃⁻-co-P3HT complexed with imidazolium functionalized acrylate) or PVDF in accordance with an embodiment. Capacity retention of composite cathodes (FIG. 11A) shown as specific capacity vs. cycle number and (FIG. 11B) shown as capacity retention, where each cycle's discharge capacity is normalized to that of the first cycle. FIGS. 11C and 11D show differential capacity curves for the initial formation cycle at C/10, and for the 1^{st}, 100^{th}, 200^{th}, 300^{th} and 400^{th} C/2 cycles of the stability test.

In several embodiments, the complex binders are stable over many cycles, and maintain the higher utilization at C/2 when compared to PVDF (FIG. 11A). While the PVDF control cell is stable, it has poorer utilization at the C/2 rate. The normalized capacity vs. cycle number (FIG. 11B) probes the reversibility of the redox reactions over many charge-discharge cycles, irrespective of the initial cathode utilization (greater for the CPC cell than the PVDF cell). Over the first 100 cycles, the reactions taking place within the CPC and PVDF cells appear to be similarly stable, leading to 93% and 92% capacity retention, respectively. Beyond cycle 100, the capacity retention of the CPC cell is significantly better than that of the PVDF cell, as it maintains 72% of its initial capacity at cycle 300 and 63% at cycle 400 (compared to 61% and 6% for the PVDF cell).

The origin of the capacity fade is likely not binder degradation, as PVDF is known to be electrochemically stable, but rather parasitic side reactions aggravated by the use of a resistive binder. Hereafter, differential capacity (dQ/dV) analysis is used to identify even subtle changes in electrochemical behavior and side reactions that occur during cycling. FIGS. 11C and 11D show the dQ/dV curves corresponding to the 1^{st}, 100^{th}, 200^{th}, 300^{th} and 400^{th} C/2 cycles during the stability test, as well as the initial formation cycle at C/10 for comparison. The plateaus in the potential profiles result in well-defined peaks in the dQ/dV curves, making the evolution of redox reactions and increase in overpotential easier to identify in the differential data. The dQ/dV curves of the CPC cell exhibit a single, well-defined redox peak as expected for the two-phase reaction between the LiFePO₄ and FePO₄ end-members on charge and discharge. Upon cycling the CPC cell at C/2, only minor changes to the dQ/dV peaks occur over 400 cycles, indicating minimal structural degradation of the LFP cathode particles and negligible side reactions. Additionally, the overpotential recorded at C/2 is only slightly higher than that recorded at C/10 and does not increase substantially over 400 cycles. On the other hand, new dQ/dV peaks appear for the PVDF cell upon cycling, and are clearly apparent at cycles 200, 300, and 400, indicating structural degradation of the LFP particles and/or side reactions upon extended cycling. Additionally, a large increase in overpotential is noted from C/10 to C/2 cycling, and again during the progression of the C/2 stability test. The increasing overpotential on charge likely triggers further side reactions as cycling goes on, exacerbating electrochemical instabilities. In particular, these side reactions likely involve the LiPF₆ electrolyte salt, as cells utilizing an LiTFSI salt instead show no sign of side reactions or overpotential growth in either the CPC or PVDF cells. Carbonate LiPF₆ electrolytes are well known to undergo many decomposition reactions, producing LiF, POF₃, POF₂(OH), and POF(OH)₂, which can form ionically insulating surface layers, as well as HF that causes Fe dissolution from LFP. While LiTFSI is known to be a more stable salt, LiPF₆ is still used due to its lower cost. Thus, improving the long-term stability of cells utilizing LiPF₆ has substantial relevance for real world applications. Overall, by improving the reversibility of the redox reactions, the CPC binder mitigates structural degradation of the cathode particles, overpotential growth, and side reactions, resulting in exceptional cycling stability for the LFP cathode.

Many embodiments implement conducting polymer complex as a binder in LiFePO₄ cathodes. The conductive polymer binder in accordance with several embodiments is an effective modification to improve charge transport within the electrode, an area where this material normally suffers. The conjugated coacervate enables a high-solids loading, viscous solution that is highly processable compared to most electrically conductive polymers. In some embodiments, electrostatic interactions between the oppositely charge sidechains can prevent dissolution in the polar electrolyte, enabling stability over many cycles. By reducing kinetic overpotential and increasing the apparent lithium diffusion coefficient, the conductive polymer binder enables rate performance of about 65 mAh/g at 6 C, while the PVDF cell can only achieve about 2 mAh/g. Certain embodiments provide that the complex binder can provide sufficient electrical conductivity to enable carbon free cathodes with a discharge capacity of about 126 mAh/g at C/2, whereas the PVDF-containing composite is unable to cycle at this rate in the absence of conductive additive. Some embodiments improve LFP cathodes rate capability and stability, as the ionic crosslinks prevent dissolution of the binder, proving stable over 400 cycles. LFP composite cathodes based on the CPC binder show exceptional cycling stability, with a 93% and 63% capacity retention after 100 and 400 cycles at C/2, respectively, compared to a 92% and 6% retention at cycles 100 and 400 when using a PVDF binder. This can be attributed to the negligible structural degradation of the LFP particles, increase in overpotential, and side reactions in the presence of a the newly-developed conducting binder. The conducting polymer complex as binders in accordance with many embodiments can achieve performance improvements in LFP batteries targeted at high power applications, such as electric vehicles.

### EXEMPLARY EMBODIMENTS

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

### Example 1: Polymer Synthesis

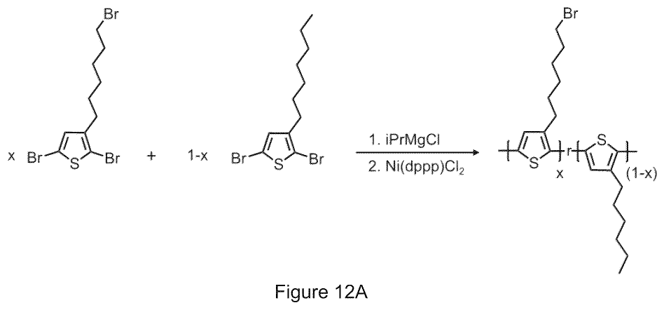

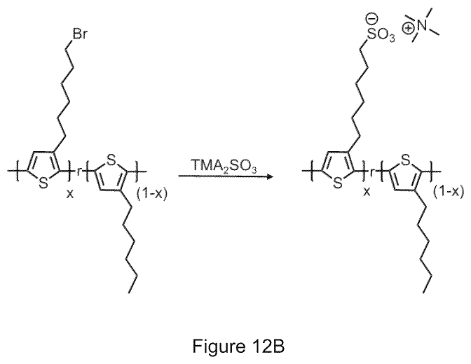

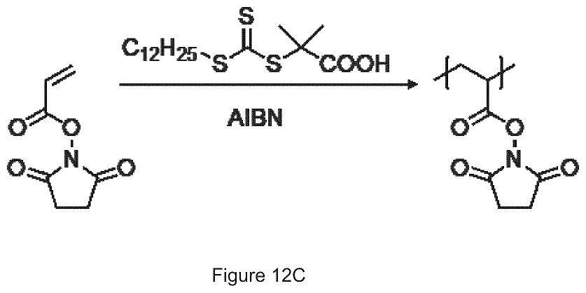

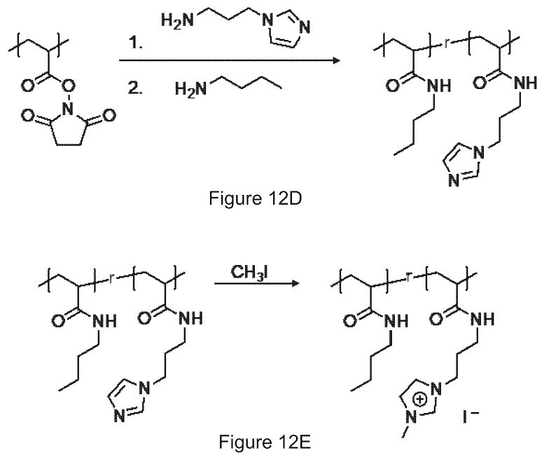

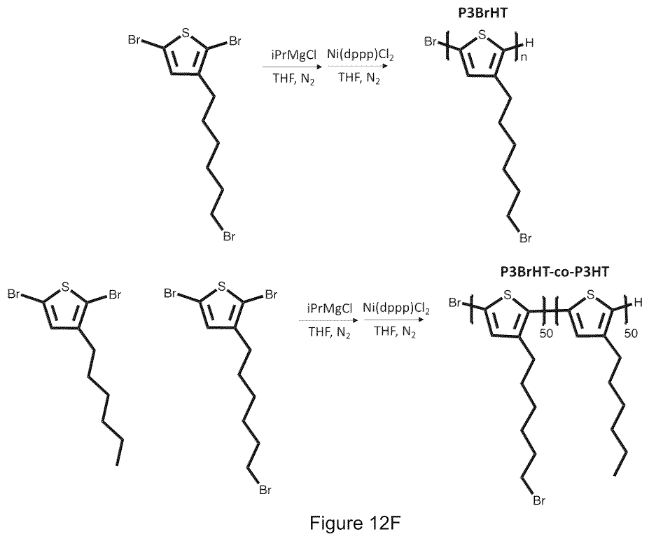

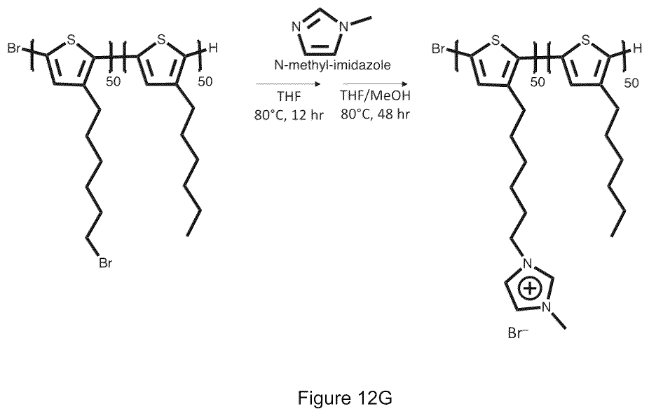

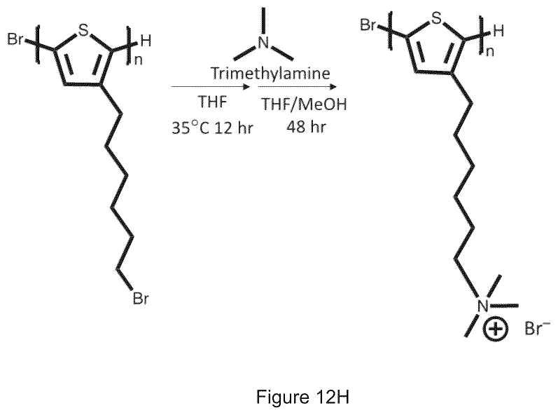

Synthesis of Poly(3-(6′-bromohexyl)thiophene-co-3-hexylthiophene) (P3BrHT:P3HT) (90:10). In an oven-dried round bottom flask equipped with a magnetic stir bar, 2,5-dibromo-3-(6-bromohexyl)thiophene and 2,5-dibromo-3-hexylthiophene are mixed in 9:1 molar ratio. The reaction flask is then sealed with rubber septa and is dried overnight under active vacuum. Anhydrous THF is added to the flask to dissolve the dry monomer mixture, and the flask is purged with dry nitrogen for 20 minutes. Isopropylmagnesium chloride is added dropwise to the reaction flask, and the mixture is stirred at ambient temperature under nitrogen. Care is taken to prevent contact of isopropylmagnesium with air during the transferring process. After 2 hours, Ni(dppp)Cl₂ suspended in dry THF is added to the reaction. Immediate color change from pale yellow to vibrant red is observed, indicating the polymerization taking place. After 12 hours, the polymerization is quenched by rapid addition of 1M HCl solution, and is precipitated into cold methanol. The obtained polymer is purified by washing in a Soxhlet apparatus with methanol, acetone, and ethyl acetate respectively before extraction with THF. The product was concentrated under vacuum, yielding a red-purple solid. FIG. 12A illustrates a synthesis scheme of (P3BrHT:P3HT) (90:10) in accordance with an embodiment. The isolated product was then dried overnight under vacuum to remove any remaining solvent. H¹ NMR (600 MHz) in CDCl3: δ 7.0 (1H, s), δ 3.4 (1.74H, t), δ 2.8 (1.41H, t), δ 1.5-1.8 (8.1H, m), δ 0.9 (0.32H, t). GPC in THF (PS standard): Mn=13.6 kDa, Mw=20.6 kDa, Ð=1.52.

Synthesis of Poly[6-(thiophen-3-yl)hexane-1-sulfonate-co-3-(hexylthiophene)](PTHS:P3HT) (90:10). In a round bottom flask equipped with a magnetic stir bar, P3BrHT-P3HT is dissolved with THF. The flask is sealed with a rubber septa, and the solution is purged with dry nitrogen gas for 30 minutes. 1M bis(tetramethylammonium)sulfite (TMA2SO3) salt solution in methanol is prepared. 10-fold excess of TMA2SO3 is added to the reaction flask, and the mixture is heated to 70° C. and refluxed for 1 hour. After that, more methanol is added to the reaction mixture to help dissolve the ionic-functionalized polymer and drive the reaction to completion. The reaction mixture is left to react overnight. The polymer is purified by dialyzing using 10 kDa cutoff dialysis membranes against deionized water for 3 days, with the dialysate replaced every 12 h. The isolated product is dried with lyophilizer, yielding the CPE as a red-purple solid. FIG. 12B illustrates a synthesis scheme of (PTHS:P3HT) (90:10) in accordance with an embodiment. H¹ NMR (600 MHz) in Methanol: δ 7.1 (1H, s), δ 2.8 (3.9H, t), δ 1.8-1.5 (7.78H, m), δ 0.93 (0.305H, t).

Synthesis of Poly(N-hydroxysuccinimidyl acrylate) (PNHSA). In a Schlenk flask equipped with a magnetic stir bar, N-acryloxysuccinimide, DDMAT, and AIBN are dissolved in anhydrous DMF. The solution is degassed using five freeze-pump-thaw cycles. After the fifth cycle, the flask is filled with dry nitrogen and heated to 70° C. in an oil bath. The reaction is kept at that temperature for 24 h, and during the process the mixture was stirred vigorously. After cooling to 25° C., the polymer is precipitated from methanol, filtered and dried in ambient, dissolved in DMF and reprecipitated from methanol, twice. The polymer is filtered and dried under a vacuum at 60° C. for 24 h to yield a pale-yellow powder. FIG. 12C illustrates a synthesis scheme of PNHSA in accordance with an embodiment. NMR end-group analysis indicate an average DP of 82 for the PIL. H¹ NMR (600 MHz) in DMSO: δ 3.13 (27H, br), δ 2.80 (125H, br), δ 2.05 (55.6H, br), δ 1.27 (6.3H, s), δ 0.8 (1H, t).

Synthesis of Poly[(1-propylimidazolacrylamide)-co-3-methyl-1-(propyl acrylamide)]. PNHSA repeat units are randomly functionalized with imidazole-amine and butylamine. The polymer is first dissolved in anhydrous DMF in a round bottom flask. The flask is sealed with rubber septa and degassed with dry nitrogen for 30 minutes. After that, 0.9 molar equivalent of 1-(3-aminopropyl)imidazole solution in anhydrous DMF is added dropwise to the vigorously stirring polymer solution. The reaction is left running for 12 hours at 25° C. using a water bath. The resulting polymer is precipitated from ethyl acetate, dissolved in methanol, and re-precipitated from diethyl ether twice. The polymer is collected by centrifugation and dried under a vacuum at 60° C. for 12 h to obtain a pale-yellow brittle solid. It is then dissolved in anhydrous DMF and the NHSA groups are reacted with 5-fold excess of butylamine for 12 h at 25° C. f to yield the neutral random copolymers. FIG. 12D illustrates a synthesis scheme of poly[(1-propylimidazolacrylamide)-co-3-methyl-1-(propyl acrylamide)] in accordance with an embodiment. Integrations of the Imidazolium proton peaks δ 7.6 (17H, s), δ 7.1 (17H, s), δ 6.9 (17H, s) suggests an average 75 repeat units per chain were functionalized, corresponding to a charge fraction of 91%.

Synthesis of Poly[(3-methyl-1-propylimidazolylacrylamide)-co-3-methyl-1-(propylacrylamide)]. In a round bottom flask, the neutral copolymer is dissolved in anhydrous DMF. The flask is sealed with a rubber septa, and the solution mixture is purged for 30 minutes using dry nitrogen. 3-fold excess of iodomethane (with respect the imidazole) is added to the flask, and the reaction mixture was heated slightly and kept at 40° C. for 12 hours. The polymer is then precipitated from diethyl ether and dried under vacuum overnight. The iodine anion is exchanged to chloride by co-dissolving the polymer in methanol with 10-fold excess of NaCl. This mixture is stirred vigorously at 45° C. overnight. After that, the solution mixture is dialyzed using a 10 kDa cutoff dialysis membranes against methanol for 4 days, with the dialysate replaced every 12 h. The isolated product is dried under vacuum at 90° C. for 24 h, yielding an off-white solid. FIG. 12E illustrates a synthesis scheme of poly[(3-methyl-1-propylimidazolylacrylamide)-co-3-methyl-1-(propylacrylamide)] in accordance with an embodiment.

Synthesis of poly(3-(6′-bromohexyl)thiophene) (P3BrHT) and P3BrHT-co-P3HT (50:50) random copolymer synthesis. 1 eq of 2,5 dibromo-3-(6-bromohexyl)thiophene or 0.5 eq. of 2,5 dibromo-3-(6-bromohexyl)thiophene and 0.5 eq of 2,5-dibromo-3-hexylthiophene were added to an oven-dried Schlenk flask, which is placed under vacuum for 2 hours. Dry, degassed THF is added via syringe and the mixture was sparged with Nitrogen. Isopropylmagnesium chloride (1.01 eq) is added dropwise and the mixture was stirred for 1.5 hr at ambient temperature under Nitrogen. 0.01 eq. of Ni(dppp)Cl₂ is added via syringe. The polymerization is stirred for 12 hr then quenched by rapid addition of 1M HCl and precipitated into methanol. The polymer is purified by washing in a Soxhlet apparatus with methanol and acetone before extraction with THF. The product is concentrated under vacuum. FIG. 12F illustrates a synthesis scheme of P3BrHT and P3BrHT-co-P3HT (50:50) in accordance with an embodiment. P3BrHT 1H NMR (600 MHz, CDCl3) δ 7.18-6.92 (s, 1H), 3.53-3.37 (m, 2H), 2.93-2.55 (m, 2H), 2.04-1.81 (m, 2H), 1.80-1.58 (m, 2H), 1.57-1.30 (m, 4H). P3BrHT-co-P3HT 1H NMR (600 MHz, CDCl3) δ 7.19-6.73 (s, 1H), 3.53-3.37 (m, 2H), 2.91-2.55 (m, 2H), 1.93 (m, 2H), 1.61 (m, 2H), 1.48 (m, 2H), 1.39 (m, 2H), 0.81 (t, 3H). Gel permeation chromatography is performed on a Waters e2695 equipped with THF as the mobile phase. Results are quantified using a polystyrene standard calibrant.: P3BrHT⁻: Mn=16 kDa, Mw=22 kDa, Ð=1.4, P3BrHT-co-P3HT: Mn=13 kDa, Mw=17 kDa, Ð=1.3.

Post polymerization of poly(3-(6′-(N-methylimidazolium)hexyl)thiophene). The P3BrHT or P3BrHT-co-P3HT polymer is post-functionalized through an amine quaternization reaction. The polymer was first dissolved in THF. 1-methylimidazole (10 eq.) is added to the solution in ambient conditions. The solution is then stirred for 12 h under reflux. After 12 h, some polymer precipitate is observed in the flask. A small amount of methanol is added to fully dissolve the resulting polymer and the solution is stirred for an additional 24 hours to help achieve quantitative conversion. The polymer is then dialyzed using a 10 kDa cutoff dialysis membrane against a mixture of methanol and THF, with the dialysate replaced every 12 h. FIG. 12G illustrates a scheme of post-polymerization functionalization to form P3HT-Im⁺Br⁻ and P3HT-Im⁺Br⁻-co-P3HT in accordance with an embodiment.

Post polymerization of poly(3-(6′-trimethylammonium)hexyl)thiophene). The P3BrHT polymer is post-functionalized through an amine quaternization reaction. The polymer is first dissolved in THF. Trimethylamine (10 eq.) is added to the solution in ambient conditions. The solution is then stirred for 12 h at 35° C. After 12 h, some polymer precipitate is observed in the flask. Methanol is added to fully dissolve the resulting polymer, and an additional 2 eq of trimethylamine is added. The solution is stirred for an additional 24 hours, then the temperature is increased to 80° C. and the system is refluxed for an additional 24 hours. The polymer is then dialyzed using a 10 kDa cutoff dialysis membrane against a mixture of methanol and THF, with the dialysate replaced every 12 hours. FIG. 12H illustrates a scheme of post-polymerization functionalization to form P3HT-TMA⁺Br⁻ in accordance with an embodiment.

### Example 2: Polymer Complexation

Coacervation can be driven by the combination of electrostatic attraction of oppositely charged polymers and entropy gained via the expulsion of the remaining counterions. This driving force is so large that it overcomes the repulsive interactions of the otherwise immiscible polymer backbones and results in a dense coacervate phase and a dilute supernatant phase. While in the fluid state, the polymer-rich coacervate phase has high solids loading (on the order of about 50 wt. %) and low viscosity, when this phase is dried, ionic crosslinks between side chains provide insolubility in many common solvents. As a result, polyelectrolyte complexes enable a diverse array of backbone and side chain architectures to be implemented in homogenous systems, offering immense tunability of electronic, ionic, and mechanical properties. In conjugated polymer coacervates, complexation affords the solubility, miscibility, and processing advantages already mentioned, but can also affect optoelectronic and conduction properties, as structural templating of the conjugated polymer occurs during complexation, resulting in a planarized backbone with highly delocalized excited states. Additionally, conjugated polymer complexes can form high solids loading, viscous coacervate phases, substantially improving processability compared to single component conjugated polymers. Thus, conjugated polymer complexes combine the tunability and processability of polymer complexes with the electronic conductivity of conjugated polymers, making them promising materials for electrochemical applications.

Improved conductivity and stability can be achieved of conjugated polyelectrolyte complexes in accordance with many embodiments. A variety of charged, ionic groups can enable polyelectrolyte complexation, which affords both facile processing during electrode fabrication and good stability during cycling. This can be important as it allows for the incorporation of relatively inexpensive, commodity polyelectrolytes as a component of the binder. Electrostatic interactions compatibilize the two polymers, initially forming a coacervate phase which maintains the ability to flow and form coatings. Upon drying of the electrode slurry, the ionic interactions between the two polyelectrolytes form strong cross-links, leading to good stability during cycling. The intrinsic electronic conductivity, ionic conductivity, lithium transference, and electrochemical stability of the complexes display similar advantageous properties such as a broad electrochemical stability window, high conductivity, and lack of dissolution in a standard battery electrolyte (1M LiPF₆ 1:1 v EC:DMC). The complex can improve the rate capability when applied as a binder in LiFePO₄ cathodes.

Polymer concentrations of 1M in 40/60 THF/water are selected to ensure formation of a viscous coacervate (rather than precipitate). Equimolar ratios of each polymer are added to a centrifuge tube, vortexed, then centrifuged for 10 min at 7,000 rpm. The resulting mixture consisted of a viscous complex, and a dilute supernatant phase-containing released counterions and dilute polymer. The supernatant is thoroughly rinsed off using the THF/water mixture. The mass that is removed and weighed in order to inform the remaining mass of polymer complex, which would later be used as the binder.

### Example 3: Electronic and Ionic Conductivity

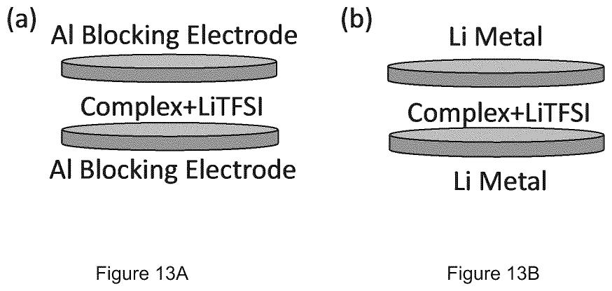

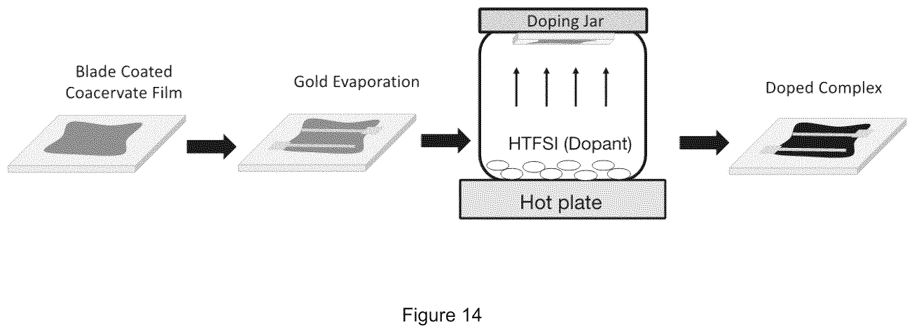

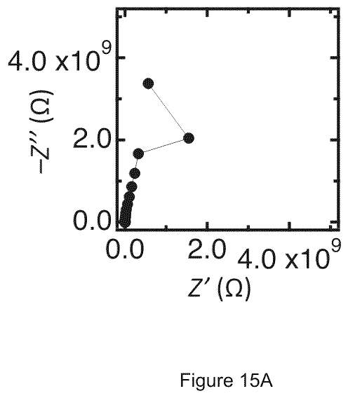

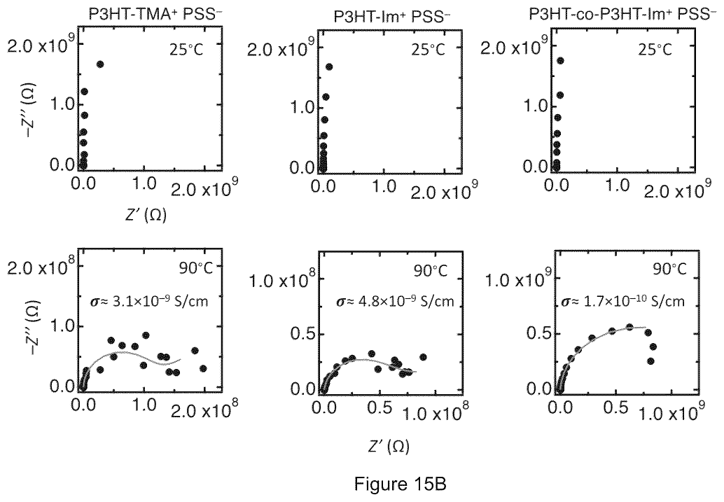

Measuring intrinsic transport properties, in addition to battery performance, is valuable in order to establish fundamental mixed conduction structure-property relationships. FIGS. 13A and 13B, and FIG. 14 show schematics of sample setups for bulk ionic conductivity, lithium transference, and electronic conductivity. For all measurements, washing the complex with a 40/60 (v/v) THF/water mixture ensured the bulk of the sidechain counterions are removed. This is evidenced by the lack of ionic conductivity of the complex, shown in FIGS. 15A and 15B. For ionic conductivity and transference measurements, controlled amounts of LiTFSI are introduced after washing but prior to drying. LiTFSI is selected (rather than LiPF₆), as variable temperature measurements are typically performed in ion conducting polymers, and LiPF₆ degrades at relatively low temperatures. Ionic conductivity samples are cast, dried, and sandwiched between two ion blocking electrodes to enable AC impedance in a typical fashion for ion conducting polymers. Transference measurements use a similar geometry, but utilize lithium metal electrode to enable the DC polarization technique. Electronic conductivity is performed on vapor doped thin films.

Ionic conductivity can be measured on bulk samples in a through plane configuration. First, isolated coacervates are thoroughly washed to remove all polymer counterions, as confirmed by the negligible ionic conductivity of the resulting system. Concentrated solutions of LiTFSI in water are then used to introduce a controlled amount of LiTFSI to the system, which is vortexed and allowed to equilibrate for 2 days, after which the complexes appear as a homogenous gel. The complex is then cast onto an aluminum current collector with a well-defined thickness provided by the use of a Kapton spacer. The sample is then dried at 110° C. to 150° C. at 10⁻⁸ torr for 12 hours to remove any trace solvent. Samples are then loaded into an argon glovebox and a second aluminum current collector is pressed on top of the sample to afford through plane EIS conductivity measurements.

For electrolyte swollen conductivity measurements, the complex is prepared, cast, and dried as describe above. PVDF is solvent cast using NMP, then dried at 110° C. to 150° C. at 10⁻⁸ torr for 12 hours in the same manner as the complex. After drying, the samples are loaded into a glovebox and excess electrolyte (1M LiPF₆ in 1:1 EC:DMC) is pipetted onto the top surface of the samples. Samples are allowed to passively swell and equilibrate for 24 hours. After 24 hours, excess electrolyte is removed via wicking with a Kimwipe. The samples are then sealed with the top aluminum current collector and measured.

For measurement, samples are placed into a controlled environment sample holder, which maintains an inert atmosphere during measurement. Variable temperature conductivity measurements are performed using an intermediate temperature system in conjunction with a potentiostat. A sinusoidal voltage with amplitude 100 mV is applied in the frequency range of 0.1 Hz-3 MHz. Data is then fit to the equivalent circuit to extract the resistance. From these equivalent DC resistances, conductivity can be calculated according to the following:

$$σ = \frac{1}{R} \frac{t}{A}$$

where t is the thickness of the polymer film and A is the area, both of which are defined by the Kapton spacer.

For electrical conductivity, custom made silicon substrates with gold digits can be used. CPE samples can be spun cast from 10 mg/mL polymer solutions at 1000 rpm for about 60 seconds. Samples are dried/annealed under high vacuum (2×10⁻⁸ torr) at 130° C. for 12 hours. Film thickness can be determined by ellipsometry.

HTFSI (vapor) can be used as the dopant to probe the electrical conductivity of the CPE's and complexes and to allow for direct comparison as to the impacts of complexation on electronic conductivity. Inside a nitrogen filled glovebox, pristine films can be attached to the lid of a jar containing HTFSI crystals using double sided Kapton tape. The sealed jar is placed on the hot plate set at 50° C. for 1, 3, and 12 hours. DC conductivity measurements are performed by applying DC potentials between −1V and 1V at 100 mV intervals. Once resistance was determined, conductivity can be found using the following equation:

$$σ = \frac{1}{R} \frac{d}{l h}$$

where σ is the conductivity, R is the resistance, d is the distance between the gold digits, l is the length of each digit, and h is the polymer film thickness. Here, l=2.7 mm and d=100 μm, 150 μm, and 200 μm, as the substrate utilized several groups of digits at these 3 spacings, of which the average results are reported.

DC polarization is performed on symmetric lithium-polymer-lithium cells. Samples are assembled in an argon glovebox utilizing a controlled environment sample holder and tested using their intermediate temperature system in conjunction with a potentiostat to 80° C. It is common to perform this test at elevated temperature in order to improve signal to noise (due to higher ionic current at elevated temperature). Samples are allowed to rest for 12 hours after construction and are then equilibrated at 80° C. and monitored via EIS until the system stabilized. Next, a 100 mV potential bias is applied and the resulting current measured over time. EIS measurements with a 20 mV amplitude are performed at 40-minute intervals to monitor changes in the interfacial resistance. Lithium transference numbers were calculated following the method of Bruce and Vincent:

$${t}_{L i +} = \frac{{I}_{ss} ( Δ V - {I}_{Ω} {R}_{0} )}{{I}_{Ω} ( Δ V - {I}_{ss} {R}_{ss} )}$$

Here, ΔV is the applied potential (100 mV), R₀ and Rₛₛ are the initial and steady-state interfacial resistances, respectively, Iₛₛ is the steady-state current, and I_{Ω} is the initial current determined from Ohm's law:

$${I}_{Ω} = \frac{Δ V}{{R}_{Ω}}$$

where R_{Ω} is the initial cell resistance (bulk and interfacial) measured by EIS. Using In instead of the initial current measured by the potentiostat eliminates errors related to the speed at which the instrument can record the current.

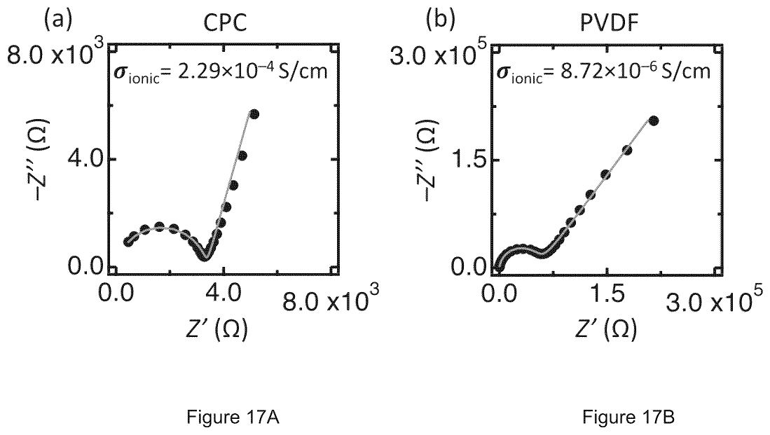

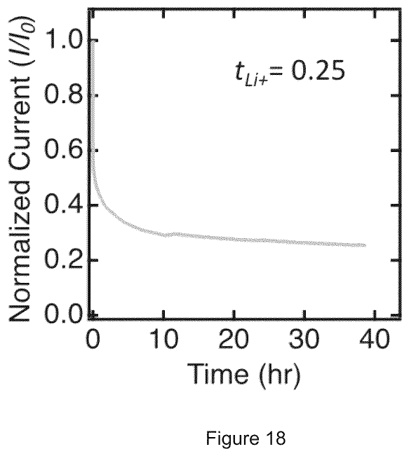

Despite the stabilizing ionic cross links, the conjugated polymer complex experiences a monotonic increase in conductivity from r=0.25 to r=1.0 LiTFSI, indicating the complex intrinsically has a good ability to solvate and transport ions. A maximum room temperature conductivity of 6.05×10-8 S/cm is achieved at r=1.0 LiTFSI. Measurements of the electrolyte swollen system are presented and discussed below in FIG. 17. As FIG. 18 indicates, there is also reasonable lithium transference, indicating good mobility of Li+ through the complex.

The intrinsic ionic conductivity of PVDF is too low to be measured in the same manner as that of the CPC binder, as PVDF cannot solvate salt in its dry state. However, during actual battery operation, the polymer binder is swollen by liquid electrolyte and in this swollen state exhibits appreciable ion transport. Hence, to better mimic polymer binders in a normal battery environment, measurements of the ionic conductivity of the polymers are performed on electrolyte-swollen systems. The swollen CPC achieves an ionic conductivity of 2.29×10⁻⁴ S/cm, nearly two orders of magnitude higher than that of swollen PVDF (FIG. 17). To determine these values, the polymers are cast, dried, and then exposed to excess electrolyte for 24 hours. The excess electrolyte is then removed, and the ionic conductivity is measured on the passively swollen polymers. The resulting ionic conductivity is thus a function of the polymer's affinity to swell with electrolyte. The results are consistent with the higher intrinsic ionic conductivity of the CPC, as the charged sidechains that facilitate ion transport should also provide enhanced electrolyte swelling compared to PVDF.

FIGS. 13A and 13B illustrate a schematic of the setup used to determine intrinsic ionic transport properties of the complex in accordance with an embodiment. The setup is the same for ionic conductivity (13A) and lithium transference (13B), with the difference being the former uses blocking electrodes. In each, the polymer is sandwiched between two metal electrodes. For ionic conductivity, these electrodes are selected to be aluminum, which are blocking to all ionic charge carriers. For t_{Li+} measurements, lithium metal is used, as this is blocking to all ionic charge carriers other than Li⁺, enabling the determination of the steady state lithium ion current.

FIG. 14 illustrates a schematic of the setup used to determine intrinsic electronic transport properties of the complex in accordance with an embodiment. Complex are first blade coated onto quartz substrates and then dried. Next, gold electrical contacts (≈60 nm thick) are deposited at 1 Å s-1 rate onto the casted polymer film on quartz via controlled thermal evaporation through a shadow mask. Transmission line measurements are carried out to determine in-plane electronic conductivity of the polymer film using a picoammeter. Measurements are carried out inside a nitrogen glovebox at room temperature. A conductivity of 1 S/cm can be achieved.

FIGS. 15A and 15B illustrate ionic conductivity of the neat complex in accordance with an embodiment. FIG. 15A shows the complexation/washing process sufficiently removes charge compensating counterions in P3HT-SO₃⁻-co-P3HT complexed with imidazolium functionalized acrylate. The Nyquist plot is indicative of an open circuit, in line with a lack of ionic charge carriers. The line between points is provided as a guide for the eye.

FIG. 15B shows that the complexation/washing process sufficiently removes charge compensating counterions of P3HT-TMA⁺PSS⁻, P3HT-Im⁺PSS⁻, and P3HT-co-P3HT-Im⁺PSS⁻ complexes. Columns are for the indicated complex, where the top row is the data collected at 25° C. and the bottom row is the data at 90° C. At 25° C., no measurable signal appears, and the Nyquist plot is indicative of an open circuit, in line with a lack of ionic charge carriers. At 90° C., a small resemblance of a Nyquist plot indicative of ionic conductivity appears, but the result is noisy, and when fits are attempted (lines) the resulting values are extremely low, again indicating negligible ionic conduction in the neat complexes.

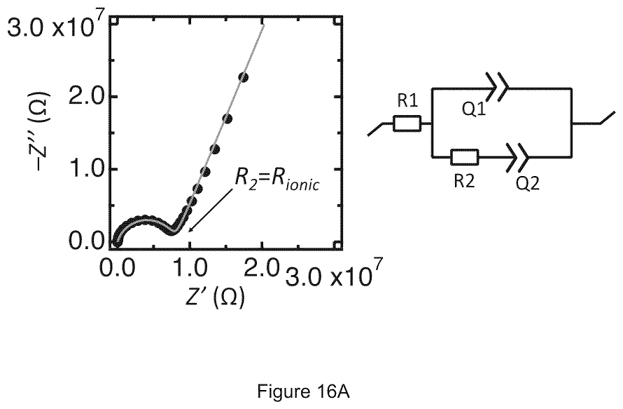

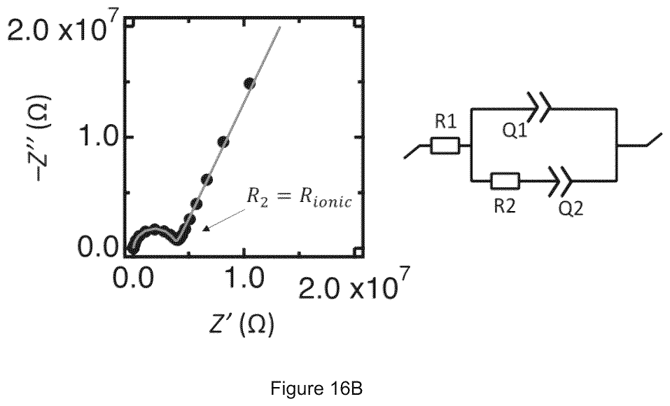

FIG. 16A illustrates Nyquist plot for the ion conducting P3HT-SO₃⁻-co-P3HT complexed with imidazolium functionalized acrylate between two symmetric blocking electrodes in accordance with an embodiment. Data is from the r=1.0 sample at room temperature (r=LiTFSI/SO₃⁻ group). Black dots represent data and the red line represents the fit obtained using the equivalent circuit shown on the right.

FIG. 16B illustrates Nyquist plot for the ion conducting complex P3HT-co-P3HT-Im⁺PSS⁻ between two, symmetric blocking electrodes in accordance with an embodiment. Data is from P3HT-co-P3HT-Im⁺PSS⁻ with r=0.5 (r=LiTFSI/SO₃⁻ group). Black dots represent data and the red line represents the fit obtained using the equivalent circuit shown on the right.

FIGS. 17A and 17B illustrate ionic conductivity data for the electrolyte swollen polymers in accordance with an embodiment. FIG. 17A shows the Nyquist plot and resulting ionic conductivity for the swollen CPC system (P3HT-SO₃⁻-co-P3HT complexed with imidazolium functionalized acrylate) and FIG. 17B shows that of swollen PVDF. For each, the polymers are cast and dried as described, then allowed to passively swell with electrolyte as outlined in the methods section. AC impedance is then performed on the swollen polymer systems. Points represent data and lines represent the fit to the equivalent circuit presented in FIG. 16A, from which ionic resistance is determined. Data is collected at room temperature.

FIG. 18 illustrates current decay for the DC polarization in accordance with an embodiment. The complex P3HT-SO₃⁻-co-P3HT complexed with imidazolium functionalized acrylate with r=1.0 LiTFSI is sandwiched between lithium metal electrodes and a DC potential is applied as described.

### Example 4: Cell Construction

Cathodes are prepared via slurry fabrication. A composition of 85:6:9 by mass (LFP:Carbon:Polymer) is used for carbon containing cells, while a composition of 85:15 (LFP:Polymer) is used for carbon free cells (keeping the LFP ratio constant and replacing carbon with additional polymer). LFP (MTI) and carbon black (Timcal super C65) are first mixed in the appropriate ratio using a mortar and pestle. The appropriate amount of this powder is then added to polymer solutions-PVDF (Solef, Solvay) in N-methyl-2-pyrrolidone (NMP) and our complex in THF/water. The slurries are thoroughly mixed then cast onto aluminum foil (MTI) using a doctor blade. The electrodes are slowly heated to 800 C until they are visually dry. They are then transferred into a vacuum chamber for 1 hr. After initial drying, the electrodes are pressed at 10 MT using a Carver press to ensure intimate contact between the current collector and electrode materials. The films are then punched into disks to obtain the electrodes, which then underwent a final drying stage for 12 hours from about 110° C. to about 150° C. and 2×10⁻⁸ torr. The average active mass loadings are around 1.5 to 2 mg cm⁻² for the carbon containing cells and 6 mg cm⁻² for the carbon free cells.

The LFP powder is a 1.45 wt. % carbon composite. Given the low electronic conductivity of LFP, it is standard for commercial materials to use a carbon composite. 1.45% is very low mass percent, compared to some composites that reach 15% carbon.

After drying, the cathodes are transferred into an argon filled glovebox (<0.5 ppm oxygen, <0.5 ppm water) for cell assembly. CR2032 coin cells (Hoshen) are fabricated with lithium metal as the anode/counter electrode and Celgard 2325 (PP/PE/PP) separators. The electrolyte is either 1M LiTFSI or 1M LiPF₆ in 1:1 ethylene carbonate and dimethyl carbonate (1/1 v/v EC:DMC) as indicated in each data set. Cells are crimped using a pressure-controlled crimper (MTI) set to 0.9 MT.

### Example 5: Testing

Both variable rate and cycle stability tests are performed using galvanostatic cycling, where the C rate is defined using the theoretical capacity of 170 mAh/g for LFP. For clarity: 1 C indicates a current such that the entire (theoretical) capacity of the cell would be utilized in 1 hour. C/2, is half that rate, meaning the capacity is utilized in 2 hours, and similarly 2 C indicates twice the capacity is utilized in 1 hour. After construction, cells are allowed to rest for 12 hours while the OCV is monitored. After this, 5 C/10 cycles are performed to ensure complete SEI formation before subsequent testing. EIS is performed at the top of charge and bottom of discharge of the 4^{th} cycle. The cells are allowed to rest for 1 hour prior to each EIS test. After the C/10 formation cycles, Galvanostatic intermittent titration technique (GITT) is performed. Here constant current (C/10 rate) is held for 1 hour, then cells are allowed to relax for 2 hours while the OCV is monitored. The sequence is repeated until 1 charge/discharge cycle is complete. After GITT, the variable rate CV test is performed. Next, variable rate cycling is performed, where cells undergo 5 cycles at each rate of C/5, C/2, 1 C, 2 C, 4 C, 6 C, and C/5. A rest period of 30 seconds is provided in between each change of cycle rate to allow for adjustment of the current range on the potentiostat. Immediately following the variable rate test, the C/2 cycle stability test is performed. Tests are performed at room temperature using a potentiostat.

### Example 6: Carbon Free Cells

The performance of cathode films containing no carbon additive further emphasizes the ability of the CPC binder to facilitate long-range electron transport within the composite cathode. Carbon is typically introduced in two forms in electrode composites: first, the active material in powder form is coated with a thin layer of carbon prior to composite fabrication to enhance the electronic conductivity of individual particles, and second, carbon black and/or carbon nanotubes are added to the slurry during electrode film fabrication to create long-range electron transport pathways. The commercial LFP active material can be coated with carbon (1.4% by mass). For the results shown in the figures, carbon black can be added to the electrode slurry to provide long-range electron transport pathways. To test whether the CPC binder provides sufficient electronic conductivity to enable reasonable cathode utilization in the absence of carbon additive, composite cathodes are prepared whereby carbon black is replaced with additional binder (85:15 wt. % LFP:binder, as opposed to 85:6:9 wt. % LFP:CB:Binder). As shown in FIGS. 8A-8C, the carbon-free cathode composite containing the CPC binder performs better than the PVDF-based cathode composite. Specifically, the PVDF-based cathode is unable to provide any discharge capacity at rates above C/5, whereas the CPC cell achieves 126 mAh/g at C/2 and 47 mAh/g at 1 C. A decrease in cell polarization is also observed for the CPC cells (FIGS. 8B and 8C), emphasizing the improvements in long-range electronic conduction provided by the CPC binder. This ability to facilitate long-range electron transport results in a lower overall resistance within the composite cathode, and thus the electronic conductivity of the CPC is an important contributor to the enhanced rate performance.

GITT results for carbon free cells provide similar insight (FIGS. 9B and 9D), but the difference in overpotential is more pronounced, as the conducting binder is the only electronic transport pathway between active material particles. While the rate capability of these carbon free cells may not support practical application for carbon free cells, these GITT result provide insight of the “in situ charge transport” ability of the CPC binder. The electronic and ionic conductivity results show the CPC has appreciable, intrinsic conductivity. However, the battery environment is very different than that of the controlled measurements on bulk samples. During battery operation, the polymer is in contact with electrolyte, excess salt, active material particle, etc. The reduction in kinetic overpotential shown in the carbon-free GITT results indicate the CPC binder does indeed have superior conductivity than PVDF, even during battery operation. Importantly, this indicates the fundamental structure property relationships for mixed-conduction in the CPC are consistent with in situ performance.

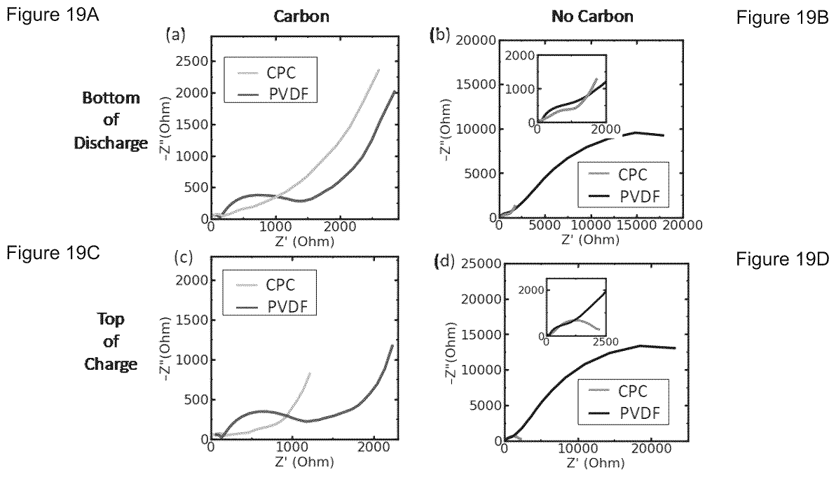

The improved kinetics afforded by the CPC binder are supported by AC impedance of both carbon containing and carbon free cells (FIGS. 19A-19D), which show smaller charge transfer resistances when the CPC is the binder compared to PVDF. The high frequency semicircle is typically associated with charge transfer processes. Compared to PVDF, cells utilizing the CPC binder show significantly smaller charge transfer resistance at both top of charge and bottom of discharge in 85:6:9 (FIGS. 19A and 19D) and 85:15 (FIGS. 19B and 19C) cells.

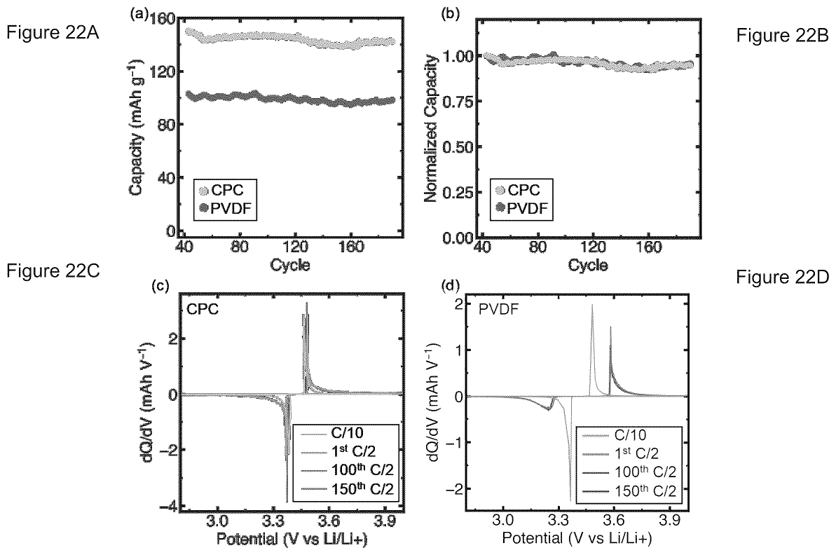

Cycle stability results for the LiTFSI cells show similar stability between the CPC and PVDF binders, confirming the conclusion that the ionic crosslinks in the CPC binder remain stable over many cycles. Both binders maintain 94% of their initial C/2 capacity over 150 cycles. As discussed, this improved stability with respect to the LiPF₆ electrolyte is not surprising given the known parasitic reactions of LiPF₆. The lack of such side reactions is evident in FIGS. 22C and 22D, which show dQ/dV analysis for cells containing the CPC and PVDF binders utilizing a 1M LiTFSI in1:1 EC:DMC electrolyte. Neither cell shows significant growth in overpotential or appearance of additional peaks, indicating little to no side reactions are occurring.

FIGS. 19A-19D illustrate Nyquist plots showing the reduction in impedance provided by the complex binder at both the top of charge (ToC) and bottom of discharge (BoD) of the 4^{th} C/10 cycle with and without carbon. CPC represents P3HT-SO₃⁻-co-P3HT complexed with imidazolium functionalized acrylate.

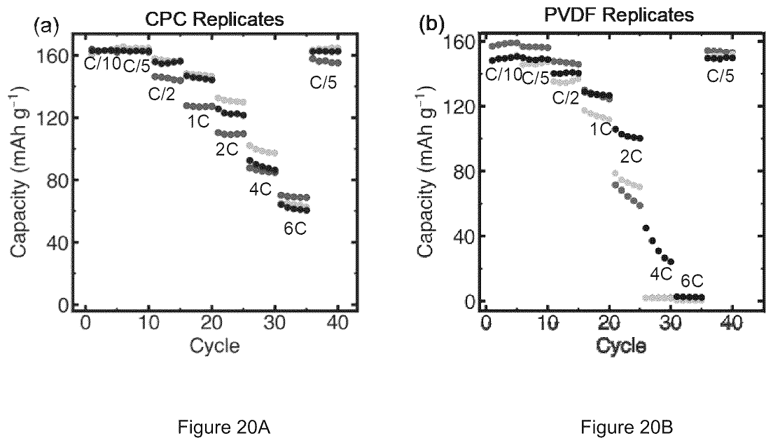

FIGS. 20A and 20B illustrate rate capability data in accordance with an embodiment showing good consistency between replicate cells containing LFP:Carbon:Binder (85:6:9 wt. %) composite cathodes for (A) the CPC binder and (B) PVDF. CPC represents P3HT-SO₃⁻-co-P3HT complexed with imidazolium functionalized acrylate.

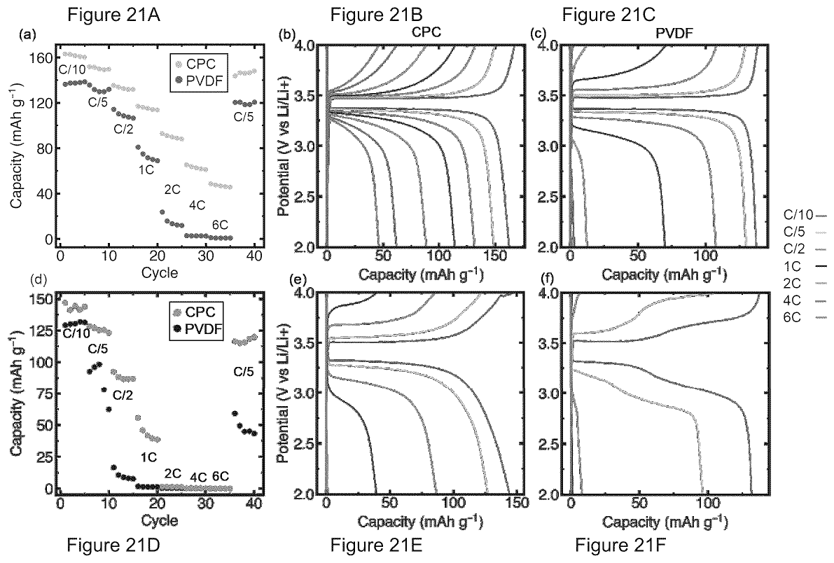

FIGS. 21A-21F illustrate variable rate data in accordance with an embodiment for 85:6:9 LFP:Carbon:Binder cells (A, B, C) and 85:15 LFP:Binder cells (D, E, F) utilizing a 1M LiTFSI in 1:1 v EC:DMC electrolyte solution. A different electrolyte is tested to probe the charge screening/solubility impacts on the complex. The complex performs better than PVDF in both LiTFSI and LiPF₆ electrolytes. CPC represents P3HT-SO₃⁻-co-P3HT complexed with imidazolium functionalized acrylate. P3HT-SO₃⁻-co-P3HT complexed with imidazolium functionalized acrylate.

FIGS. 22A-22D illustrate cycle stability data for (85:6:9 wt. %) composite cathodes utilizing a 1M LiTFSI in 1:1 v EC:DMC electrolyte solution in accordance with an embodiment. Capacity retention of composite cathodes (A) shown as specific capacity vs. cycle number and (B) shown as capacity retention, where each cycle's discharge capacity is normalized to that of the first cycle. (C) and (D) show differential capacity curves for the initial formation cycle at C/10 and for the first, 100^{th}, and 150^{th} C/2 cycle of the stability test.

### Example 7: Mixed Ion-Electron Conducting Polymer Complexes

Many embodiments provide the versatility of electrostatically-stabilized, conjugated polyelectrolyte complexes (CPCs) as conductive battery binders, with intrinsic transport properties that translate to improved rate capability of the battery. In some embodiments, the CPCs can have utility beyond liquid-electrolyte batteries towards applications including solid-electrolyte batteries and electrolyzers. As a result, the intrinsic (dry) mixed conduction properties afforded by complexation are of interest. The CPC systems can undergo a liquid-liquid phase separation upon mixing and form coacervate and supernatant phases. The complexes obtained from isolating the coacervate phases have advantageous properties, as complexation increases electronic conductivity while still affording appreciable ionic transport. The CPCs can be used as conductive battery binders.

Several embodiments implement a plurality of conducting CPCs as binders, such as polythiophenes functionalized with cationic side chains including (but not limited to) poly(3-(6′-(N-methylimidazolium)hexyl)thiophene Br⁻) (P3HT-Im⁺Br⁻), poly(3-(hexylthiophene)-co-3-(6′-(N-methylimidazolium)hexyl)thiophene Br⁻) 50:50 (P3HT-co-P3HT-Im⁺Br⁻), and poly(3-(6′-trimethylammonium)hexyl)thiophene Br⁻) (P3HT-TMA⁺Br⁻), each complexed with the sulfonate containing poly(sodium 4-styrenesulfonate) (Na⁺PSS⁻). Na⁺PSS⁻ is a low cost and commercially available polyelectrolyte, increasing the relevance of the CPC systems to real battery applications. In each system, high mixed electron-lithium conductivities are observed: electronic conductivities of up to about 0.8 S/cm accompanied by ionic conductivities of about 10⁻⁷ S/cm when dry and about 10⁻⁴ S/cm when swollen with electrolyte, with lithium transference numbers (t_{Li+}) of up to about 0.26. Additionally, each complex is stable in a liquid battery electrolyte (1M LiPF₆ in 1:1 EC:DMC), which often dissolves ionically-conducting binders. In various embodiments, the ionic crosslinks can prevent dissolution, making the CPCs desired candidates for Li-ion cathode binders, where they can provide improved rate capability compared to cells with a PVDF binder, utilizing about 70% of the cathode's capacity at 6 C compared to about 1.4% for PVDF-containing cells. Thus, by improving processability, solubility, and conductivity, the electrostatically-stabilized complexes serve as a desired platform for conductive battery binders.

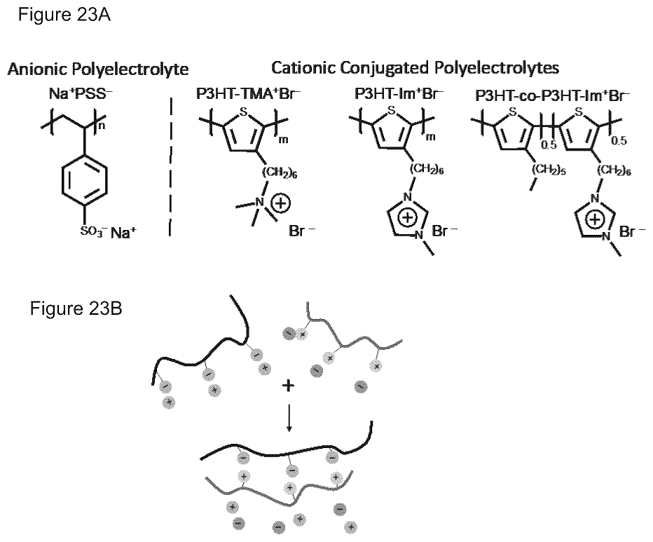

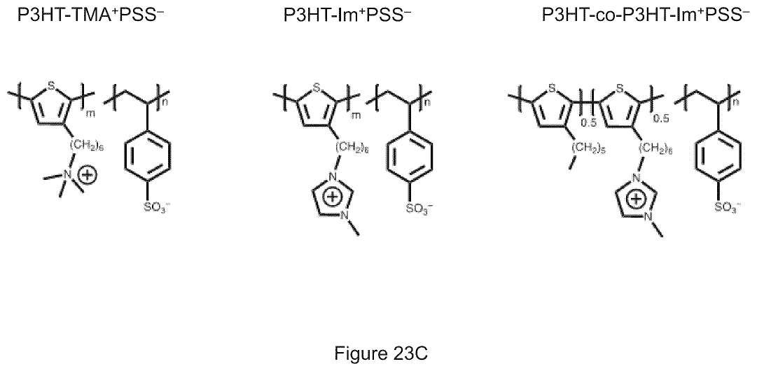

FIGS. 23A-23C illustrate conjugated polyelectrolytes in accordance with an embodiment. FIG. 23A shows conjugated polyelectrolytes bearing cationic side chains are complexed with the anionic polyelectrolyte Na⁺PSS⁻. A schematic of the general complexation scheme is shown in FIG. 23B, where the electrostatic interactions, as well as the entropy gain upon release of the counterions, makes complexation thermodynamically favorable. In a composite cathode, where the active material supports lithium ion (de)intercalation, carbon additives are added for electronic conduction, and liquid electrolyte is used for ion transport. The polymer binder is conventionally PVDF, which is insulating to charge transport. Conducting polymers remove this resistive barrier, facilitating charge transport between the active material particles, electrolyte, and current collector. FIG. 23C illustrates chemical structures of conjugated polyelectrolytes P3HT-TMA⁺PSS⁻, P3HT-Im⁺PSS⁻, and P3HT-co-P3HT-Im⁺PSS⁻.

Complexing two polyelectrolytes with oppositely charged sidechains imparts stability, (in)solubility, conductivity. Ionic interactions initially compatibilize the two polyelectrolytes into a processable coacervate phase, which upon drying/solvent removal forms hard ionic-crosslinks, preventing dissolution in the polar battery electrolyte (1M LiPF₆ in 1:1 v EC:DMC). In some embodiments, three catatonically-functionalized polythiophenes are complexed with the anionic polyelectrolyte Na⁺PSS⁻. Thiophene derivatives are advantageous for cathode applications, as they are semiconducting with low conductivities (in the insulating regime) at low potentials until oxidization occurs around 3.2V vs Li/Li⁺. This is suitable for LFP cathodes, as the flat (dis)charge voltage profile characteristic of LFP's two phase reaction occurs above this potential (around 3.4-3.5V). As a result, the binder is conductive over the entire charge/discharge cycle. Additionally, the system is electrochemically stable up to about 4.6V vs Li/Li⁺.

While each individual conjugated polyelectrolyte is soluble in the battery electrolyte, upon complexation, electrostatic interactions, along with entropy gains upon the release of the counterions, drive and stabilize the complex. This solves a major hurdle faced by many conducting polymer binders, in that high ionic conductivity is typically at odds with stability against dissolution in the electrolyte (highly polar or charged groups capable of transporting ions will also dissolve in the highly polar battery electrolyte). Finally, the complexes form a viscous coacervate phase, enabling removal of counterions and slurry coating of electrodes.

Conjugated polyelectrolyte complexes can form solutions, precipitates, and coacervate phases, however the coacervate phase is needed to achieve processability in a manner appropriate for battery applications. During complex coacervation, counterions (Na⁺ and Br⁻ for example) can be predominately released into the supernatant phase, resulting in entropic gains which, along with electrostatic interactions, make complexation thermodynamically favorable. Subsequent rinsing effectively removes residual ions, such that there is no appreciable ionic conduction in the neat complexes. Coacervates can maintain the ability to flow with relatively low viscosity, allowing formation of uniform coatings and slurry processing. Each complex studied here shows a similar ability to coacervate. Optical microscopy images of P3HT-TMA⁺PSS⁻, P3HT-Im⁺PSS⁻, and P3HT-co-P3HT-Im⁺PSS⁻ show homogenous appearance of the three CPCs, indicative of the isolated coacervate phase.

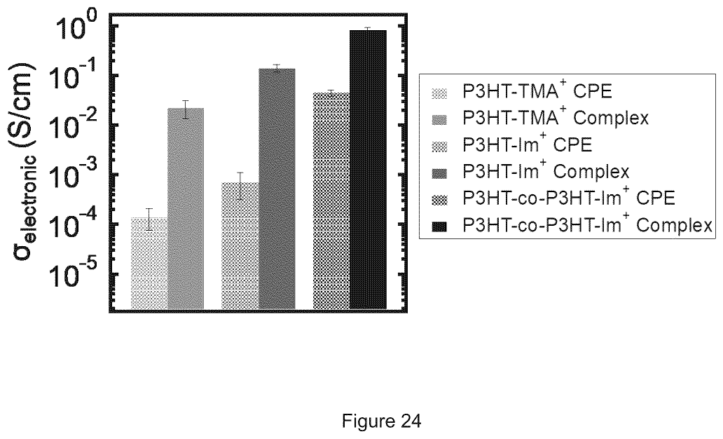

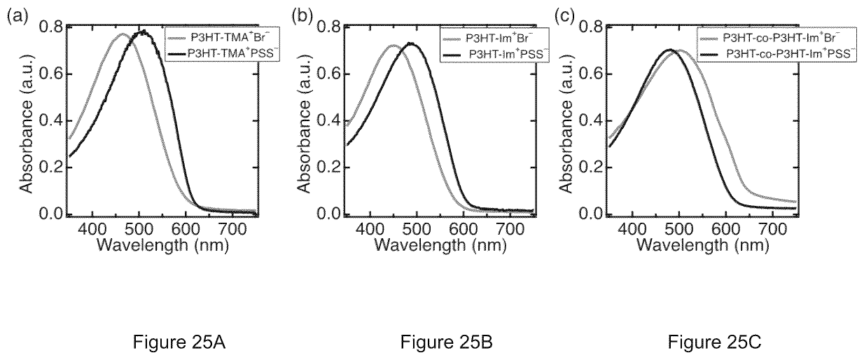

Complexation of conjugated polyelectrolytes with an insulating polyelectrolyte appears to drive chain planarization and improve the arrangements between chains resulting in increased charge mobility and higher electronic conductivity than each analogous neat conjugated polymer substituent, despite the complexes containing 50 mol % of an electronic insulator. This effect is particularly pronounced in the complexes comprising conjugated homopolymers, which demonstrate a roughly 2 order of magnitude increase in conductivity upon complexation (FIG. 24). This increase in conduction can be accompanied by planarization and conjugation length extension upon coacervation, as evidenced by a red-shift in the optical absorbance, which is consistent with the observation here for P3HT-Im⁺PSS⁻ and P3HT-TMA⁺PSS⁻ (FIGS. 25A-25C). UV-Vis absorbance shows that the neat CPE homopolymers have absorbance peaks centered around λ around 465 nm, and an absorption edge around λ around 600 nm. Upon complexation, a peak shift is observed to λ about 500 and 515 nm, and the absorption edge shifts to around λ about 627 and 634 nm (for P3HT-Im⁺PSS⁻ and P3HT-TMA⁺PSS⁻, respectively), consistent with an extension of the π-conjugation length. Interestingly, the copolymer does not experience a red shift upon complexation. However, unlike the homopolymers, P3HT-co-P3HT-Im⁺Br⁻ does display some level of order prior to complexation, with the absorbance peak centered around λ about 512 nm and an absorption edge around λ about 650, as well as the presence of a small shoulder around λ about 590 nm often associated with aggregates. This explains the higher conductivity of P3HT-co-P3HT-Im⁺Br⁻ relative to the homopolymer counterparts.

FIG. 24 illustrates electronic conductivity of HTFSI doped samples in accordance with an embodiment. Shaded bars represent data from the neat CPEs, while solid bars represent data from their respective complexes with PSS⁻. All systems display an increase in conductivity upon complexation. Vapor phase HTFSI doping is performed under several conditions.

FIGS. 25A-25C illustrate UV-Vis absorbance spectra for the neat CPEs and for their respective complexes with PSS⁻: (A) P3HT-TMA⁺, (B) P3HT-Im⁺, and (C) P3HT-co-P3HT-Im⁺ in accordance with an embodiment.

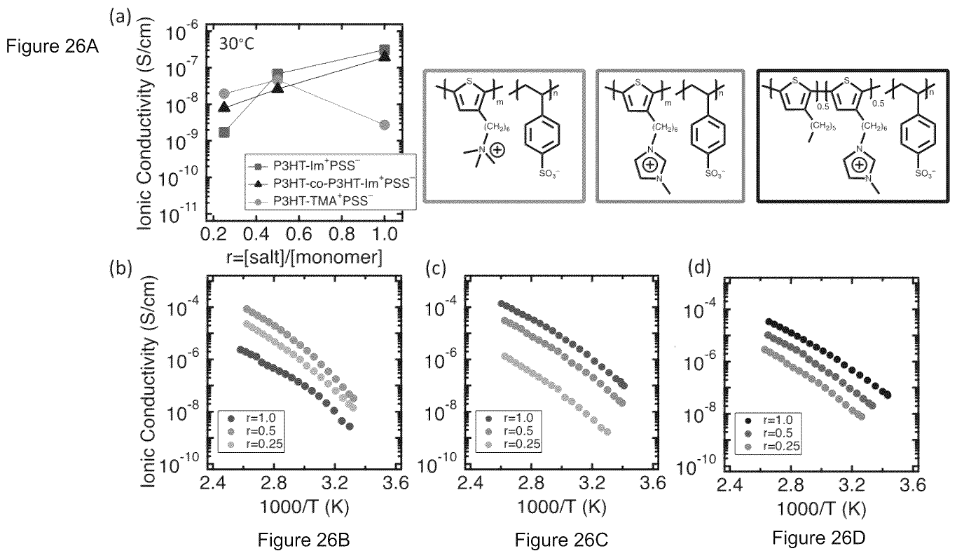

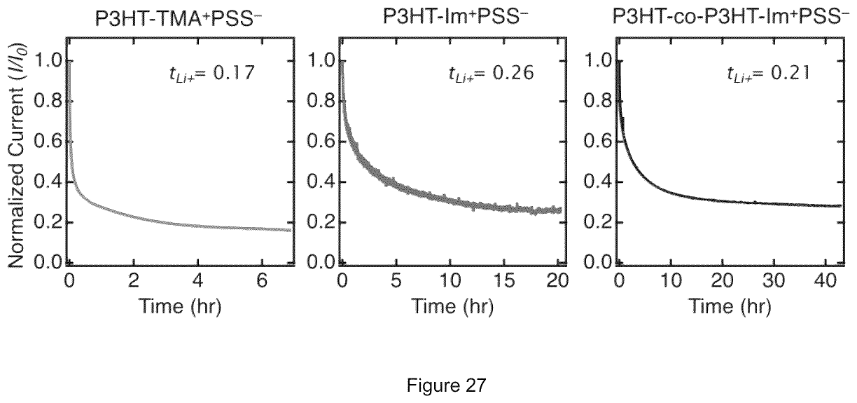

P3HT-TMA⁺PSS⁻, P3HT-Im⁺PSS⁻, and P3HT-co-P3HT-Im⁺PSS⁻ complexes show intrinsic ionic conductivity upon addition of LiTFSI, achieving conductivities over 10⁻⁷ S/cm at 30° C. and 10⁻⁵ at 80° C. (FIGS. 26A-26D). Different LiTFSI concentrations show differences in solvation capability, where the imidazolium containing CPCs display a monotonic increase in conductivity as LiTFSI is added, and the trimethylammonium CPC shows a substantial decline from r=0.5 to r=1.0. This trend results from competing effects between the higher charge carrier concentrations and reduced ion mobility resulting from ion-ion and ion-polymer interactions. Additionally, the trimethylammonium group has a more localized cationic charge, increasing ion-polymer interaction strength and reducing its ability to solvate large quantities of salt. The complexes display superior electronic conduction, establishing complexation as desired method to balance both properties in mixed conductors. Additionally, an appreciable fraction of the ionic conductivity for each complex comes specifically from the Li⁺ ion, displaying transference numbers between 0.17 and 0.26, as measured by the DC polarization method developed by Bruce and Vincent (FIG. 27).

FIGS. 26A-26D illustrate ionic conductivity as a function of (A) LiTFSI concentration and (B-D) temperature for P3HT-TMA⁺PSS⁻ (B), P3HT-Im⁺PSS⁻ (C), and P3HT-co-P3HT-Im⁺PSS⁻ (D). The diffuse imidazolium affords higher ionic conductivity both in the homopolymer and copolymer system, compared to the trimethylammonium counterpart.

FIG. 27 illustrates current decay for DC polarization study for the three complexes, where each complex is sandwiched between lithium metal electrodes and a DC potential is applied as described. Experiment performed at 80° C.

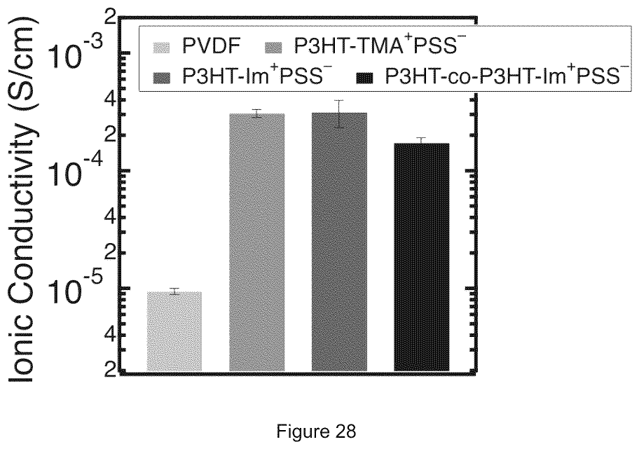

The three complexes display good transport properties, improved electronic conductivity and appreciable ionic transport, some embodiments provide characterizations in battery electrolytes. When testing in liquid electrolyte, P3HT-TMA⁺PSS⁻, P3HT-Im⁺PSS⁻, and P3HT-co-P3HT-Im⁺PSS⁻ complexes each displays higher ionic conductivity than PVDF when passively swollen with electrolyte (1M LiPF₆ in 1:1 v EC:DMC). This is unsurprising as PVDF has no ion solvating moieties, and thus no appreciable intrinsic conductivity. However, in Li-ion batteries, liquid electrolytes are used which may passively swell the polymer binder, affording ion transport even to otherwise insulating polymers. As shown in FIG. 28, the swollen complexes show ionic conductivities over an order of magnitude higher than that of swollen PVDF. FIG. 28 illustrates ionic conductivity values for polymers passively swollen with 1M LiPF₆ in 1:1 v EC:DMC. From left to right, the polymers and their respective ionic conductivities are PVDF (9.5×10⁻⁶ S/cm), P3HT-TMA⁺PSS⁻ (3.1×10⁻⁴ S/cm), P3HT-Im⁺PSS⁻ (3.1×10⁻⁴ S/cm), and P3HT-co-P3HT-Im⁺PSS⁻ (1.7×10⁻⁴ S/cm). The ionic conductivity is a direct function of the polymers' affinity to passively take up electrolyte. In the complexes, the charged side chains facilitate this electrolyte uptake to a greater extent compared to PVDF, as indicated by the electrolyte mass uptakes presented in Table 1.

TABLE 1
Electrolyte mass uptake for each polymer after exposure to a 1M LiPF₆
in 1:1 v EC:DMC solution for 24 hours. Mass uptake is defined as the
weight of electrolyte swollen into the polymer, normalized by the
original dry mass of polymer, expressed as a percentage.
Electrolyte Mass Uptake

| | | | P3HT-co-P3HT- |
|---|---|---|---|
| PVDF | P3HT-TMA⁺PSS⁻ | P3HT-Im⁺PSS⁻ | Im⁺PSS⁻ |
| 48% | 251% | 270% | 187% |

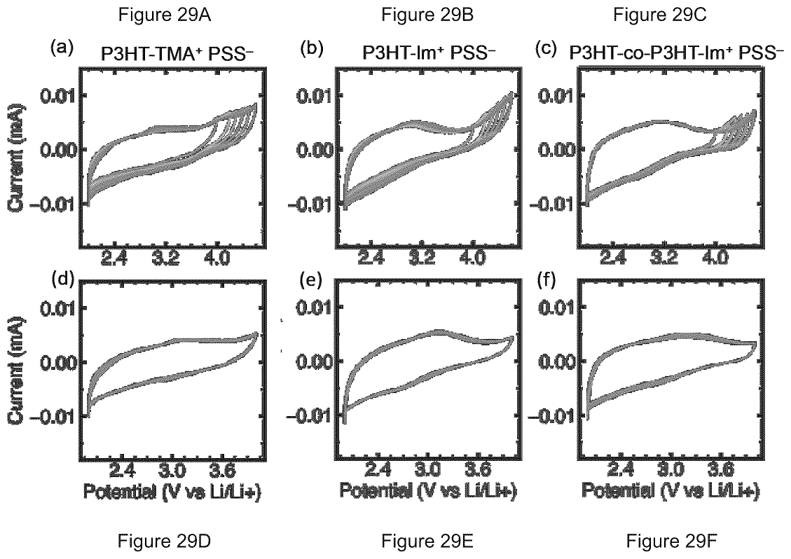

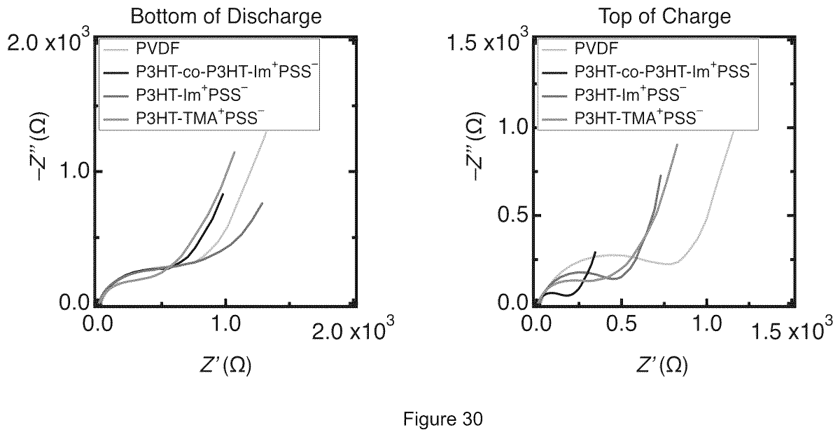

In addition to favorable ion and electron transport properties, the CPCs also demonstrate electrochemical stabilities that are sufficient for applicability as cathode binders. Three factors may be evaluated: the redox potential, lack of dissolution upon repeated cycling, and electrochemical stability over the practical potential window for an LFP half-cell. Polythiophenes (and their complexes) are neutral until doped, which occurs upon oxidation of the polythiophene backbone. FIGS. 29A-29F show that this oxidation occurs around 3.2V vs. Li/Li⁺. This means that the complex will be electronically conductive above 3.2V, which is a desired range for LFP cathodes operating near 3.4-3.5 V vs Li/Li⁺. Notably, this is consistent with the impedance data (FIG. 30) where, upon charging cells utilizing the conducting complexes as binders display reduced charged transfer resistance compared to the PVDF containing cell. The trend in these results is consistent with the electronic conductivity data, where the complex with the highest electronic conductivity (P3HT-co-P3HT-Im⁺PSS⁻) displays the largest reduction in impedance between the bottom of discharge and the top of charge.

To evaluate electrochemical stability of the CPCs over various potential ranges, 5 scans are performed over an increasingly larger potential window, from a lower bound of about 2.0 V vs Li/Li⁺ to an upper bound of about 4.0, 4.2, 4.3, 4.4, 4.5, and 4.6 V vs. Li/Li⁺. The lack of evolution of the cyclic voltammograms in FIGS. 29A-29C, combined with the consistent redox peak shape obtained, indicate that the polymer complexes are stable up to about 4.6 V vs. Li/Li⁺. Dissolution or degradation would result in either a current increase due to degradation reactions, or a decrease due to dissolution of the polymer from the working electrode. A second stability test is carried out involving 50 cycles between about 2.0 and 4.0 V vs. Li/Li⁺ to ensure no dissolution occurred over time. This can be important as the liquid electrolyte used (1M LiPF₆ in 1:1 v EC:DMC) may induce charge screening within the complex. In theory, this could drive dissolution, as each individual CPE is soluble in this electrolyte. However, the ionic crosslinks of the complexes prove sufficiently robust to avoid appreciable charge screening, rendering the CPCs insoluble as indicated by the highly reproducible CV curves in FIGS. 29D-29F.

FIGS. 29A-29F illustrate cyclic voltammograms of the three CPCs, using a lithium metal counter/reference electrode, 1M LiPF₆ in a 1:1 EC:DMC electrolyte, and the respective complex cast onto aluminum foil as the working electrode. (a-c) Stability tests upon increasing the upper potential limit, where 5 cycles at 10 mV/s were performed between a lower voltage cutoff of 2.0 V vs Li/Li⁺ and a upper cutoff of 4.0, 4.2, 4.3, 4.4, 4.5, and 4.6 V vs Li/Li⁺. (d-f) Stability tests involving 50 cycles at 10 mV/s between 2.0 and 4.0 V vs Li/Li⁺.

FIG. 30 illustrates Nyquist plots showing impedance of cells containing the indicated binders at bottom of discharge and top of charge, recorded during the final C/10 cycle. The conducting CPC binders are doped around 3.2 V vs Li/Li⁺, and thus their conductivity is enhanced over the entire charge/discharge process.

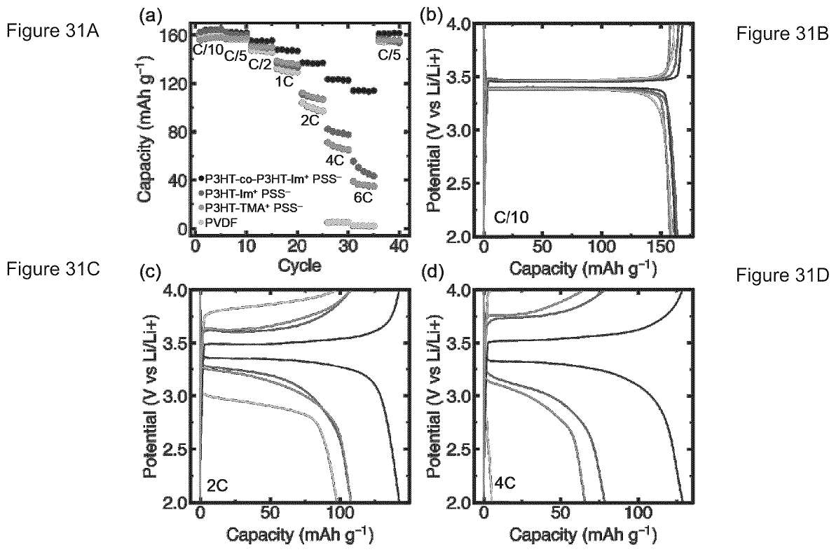

Several embodiments implement the CPCs as binders in LFP cathode films. The CPC containing cathodes show a substantial decrease in overpotential and improvement in high rate performance compared to a standard PVDF binder. To assess this, five symmetric galvanostatic charge/discharge cycles are performed at each rate of interest between C/10 and 6 C (FIG. 31A). While the P3HT-co-P3HT-Im⁺PSS⁻ complex exhibits marginally better electronic conductivity than the other CPCs, and comparable total ionic and lithium conductivity to P3HT-Im⁺PSS⁻, it has superior rate performance. The CPC containing cathodes outperform the PVDF-containing cell at high rates (4 and 6 C). At slow rates, all composite cathodes perform similarly, regardless of the binder, with cells achieving capacities of 158-163 mAh/g at C/10, and utilizing similar levels of their initial capacity (between 83% and 91%) up to 1 C. At rates higher than 1 C, appreciable performance differences begin to emerge. For instance, the P3HT-co-P3HT-Im⁺PSS⁻ binder utilizes 76% of its initial capacity at 4 C, while the P3HT-Im⁺PSS⁻, P3HT-TMA⁺PSS⁻, and PVDF containing cells utilize 49%, 43%, and 3% respectively. This trend continues at 6 C, where the composite cathode containing P3HT-co-P3HT-Im⁺PSS⁻ again performs the best, delivering 114 mAh/g (70% of the C/10 capacity). When P3HT-Im⁺PSS⁻ and P3HT-TMA⁺PSS⁻ are used as binders, a capacity of 45 mAh/g (28% of the C/10 capacity) and 39 mAh/g (25% of the C/10 capacity) is instead achieved. In contrast, the PVDF-containing cell delivers negligible capacity (2.2 mAh/g or 1.4% of the C/10 capacity). Importantly, all cells fully recover their initial slow rate capacity during the final C/5 cycles, which indicates that all cathodes are stable during high rate cycling, and performance differences stem from kinetic limitations related to PVDF's insulating properties, rather than degradation, dissolution, or other irreversible processes.

The kinetic differences observed via capacity utilization at high rates are consistent with the reduced polarization afforded by the complex binders (FIGS. 31B-31D). Cell polarization, which is derived from kinetic limitations rather than thermodynamic constraints, can leads to an overpotential. This kinetic overpotential results in an observable voltage gap between the charge and discharge processes that can be eliminated upon very slow cycling. Additionally, path hysteresis between the Li extraction and reinsertion processes can lead to a second, thermodynamic voltage hysteresis between charge and discharge. Hence, the observed voltage gap between the charge and discharge curves obtained during galvanostatic cycling is a convolution of kinetic and thermodynamic effects. Given that half-cells are prepared with a commercially-sourced LFP cathode active material, the path hysteresis is expected to be the same, and differences in the charge-discharge voltage gap between cells can provide insight as to differences in kinetic limitations associated with the different binder chemistries. For instance, the galvanostatic charge/discharge voltage profiles in FIGS. 31B-31D show that at the slow, C/10 rate, the polarization is rather similar for the CPC and PVDF cells, indicating that charge transfer through the binder is not rate limiting. However, at higher rates, smaller overpotentials during both charge and discharge are observed for cells containing the CPC binders compared to those containing PVDF. Specifically, at C/10, all cells exhibit average charge/discharge potentials of about 3.46 V and 3.35 V vs Li/Li⁺, respectively. At 2 C, polarization differences become apparent, where the PVDF cell's average charge potential is 3.86 V, and its discharge potential is 2.84 V, while those of the CPC cells are 3.52, 3.68, and 3.71 V on charge and 3.24, 3.05, and 3.03 V on discharge (for P3HT-co-P3HT-Im⁺PSS⁻, P3HT-Im⁺PSS⁻, and P3HT-TMA⁺PSS⁻ respectively). Since the binder is the only variable between the cells, these results indicate that at high rates the resistivity of PVDF is a limitation to charge transfer through the cathode composite.

FIGS. 31A-31D illustrate rate capability data for LFP:Carbon:Binder (85:6:9 wt. %) cathodes during symmetric galvanostatic charge/discharge. (a) Discharge capacity at the indicated rates. (b-d) Charge and discharge voltage profiles, reported for the 4^{th} cycle at each indicated rate.

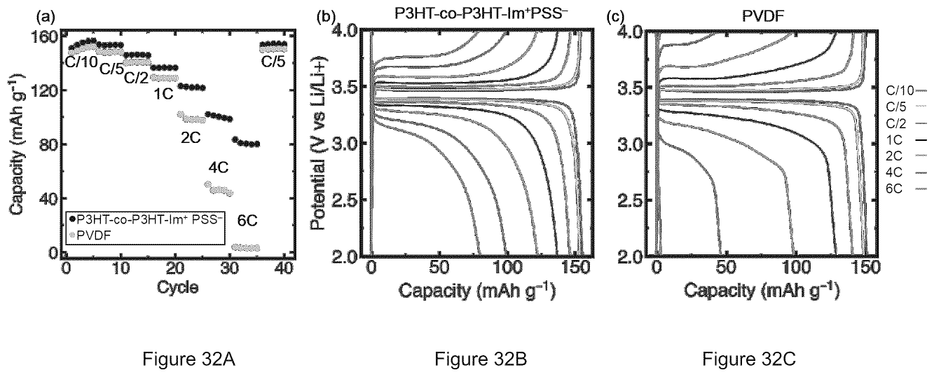

FIGS. 32A-32C illustrate rate capability for cells with lower binder content (composites containing 88:8:4 wt % LFP:Carbon:Binder, with about 5 mg cm⁻² mass loading) in accordance with an embodiment. FIG. 32A Shows discharge capacity from symmetric galvanostatic charge/discharge tests when the P3HT-co-P3HT-Im⁺PSS⁻ complex is the binder (black) and when PVDF is the binder (orange). FIGS. 32B and 32C show the potential profiles for the respective cells. While the lower binder content changes the capacity each cell obtains at high rates, the overall trend is consistent with the 85:6:9 electrodes reported in the main text, where the conducting complex enables superior rate capability compared to PVDF. Specifically, the cell using the conducting complex as a binder utilizes 52% of its maximum capacity at 6 C, while the cell with PVDF as a binder utilizes negligible capacity (2% of its maximum) at 6C.

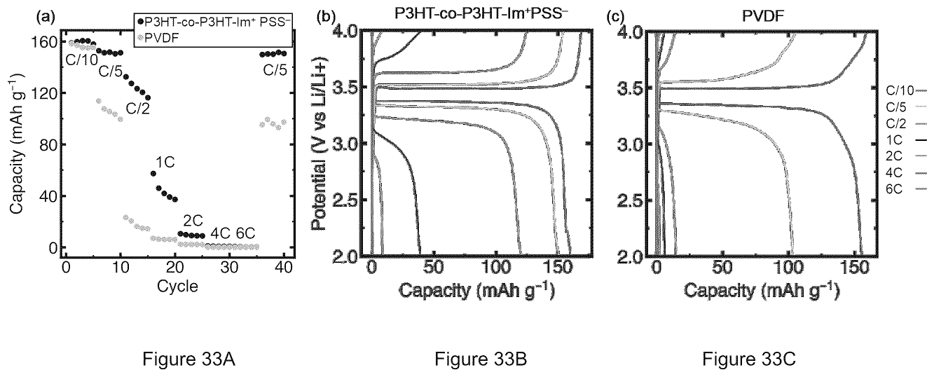

FIGS. 33A-33C illustrate rate capability for carbon-free cells (composites containing 85:15 wt % LFP:Binder, mass loading of about 6 mg cm⁻²). FIG. 33A shows discharge capacity from symmetric galvanostatic charge/discharge tests when the P3HT-co-P3HT-Im⁺PSS⁻ complex is the binder (black) and when PVDF is the binder (orange). FIGS. 33B and 33C show the potential profiles for the respective cells. In line with the data from the 85:6:9 electrodes from the main text, the conducting complex enables superior rate capability compared to PVDF.

Many embodiments implement electrostatically-stabilized complexation to impart both ionic and electronic conduction, while also provide the stability necessary for battery binder applications. Several conjugated polymer chemistries have similar properties, displaying an ionic conductivity up to about 10⁻⁵ S/cm, a lithium transference up to about 0.26 at about 80° C., and an electronic conductivity near 1 S/cm, higher than that of the conjugated polymers themselves. When applied as binders in LiFePO₄ composite cathodes, each of the P3HT-TMA⁺PSS⁻, P3HT-Im⁺PSS⁻, and P3HT-co-P3HT-Im⁺PSS⁻ complexes have higher rate capability and a reduced polarization compared to a PVDF binder. In particular, the complex containing the 50% charge fraction copolymer (P3HT-co-P3HT-Im⁺PSS⁻) performs better than the other two, delivering about 114 mAh/g (70% of its C/10 capacity) at 6 C, compared to the PVDF cell which delivers about 2.2 mAh/g (1.4% of the C/10 capacity). The applicability of conjugated polymer complexes as highly conductive battery binders shows that coacervation can be used for binder material design to achieve appreciable performance improvements for high rate Li-ion battery applications.

### EXAMPLES

Example 1: A polymer binder comprising: a conjugated polymer; and a polymer; wherein the conjugated polymer is functionalized with at least a first side chain with a first electrical charge; wherein the polymer is functionalized with at least a second side chain with a second electrical charge that is opposite from the first electrical charge such that an electrostatic interaction is formed between the conjugated polymer and the polymer; and wherein the conjugated polymer and the polymer form the polymer binder via a complexation process and the polymer binder is electrically and ionically conductive.

Example 2: The polymer binder of example 1, wherein the first side chain is balanced with a first counterion, and the second side chain is balanced with a second counterion; the first and the second counterions are released during the complexation process such that the complexation process is thermodynamically favorable.

Example 3: The polymer binder of example 1 or 2, wherein the polymer binder is configured to be a portion of a cathode of a lithium ion battery.

Example 4: The polymer binder of example 1, or 2, or 3, wherein the polymer binder is configured to form a slurry to coat the cathode and connect the cathode with a current collector.

Example 5: The polymer binder of any one of examples 1 to 4, wherein the cathode comprises an active material selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

Example 6: The polymer binder of any one of examples 1 to 5, wherein the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

Example 7: The polymer binder of any one of examples 1 to 6, wherein each of the conjugated polymer and the polymer is at least 50% charged.

Example 8: The polymer binder of any one of examples 1 to 7, wherein the polymer is a conjugated polymer or a non-conjugated polymer.

Example 9: The polymer binder of any one of examples 1 to 8, wherein the polymer is selected from the group consisting of: thiophene, propylenedioxythiophene, 3,4-ethylenedioxythiophene, bithiophene, P3HT-Im⁺, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

Example 10: The polymer binder of any one of examples 1 to 9, wherein the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

Example 11: The polymer binder of any one of examples 1 to 10, wherein the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate; wherein the second side chain has a positive charge and comprises a functional group selected from the group consisting of: an amine derivative, imidazolium, ammonium, trimethyl ammonium, triethyl ammonium, and pyridinium.

Example 12: The polymer binder of any one of examples 1 to 11, wherein the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im⁺) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

Example 13: The polymer binder of any one of examples 1 to 12, wherein the polymer binder does not dissolve in a polar electrolyte.

Example 14: A cathode, comprising: at least one active material; and a polymer binder comprising: a conjugated polymer; and a polymer; wherein the conjugated polymer is functionalized with at least a first side chain with a first electrical charge; wherein the polymer is functionalized with at least a second side chain with a second electrical charge that is opposite from the first electrical charge such that an electrostatic interaction is formed between the conjugated polymer and the polymer; and wherein the conjugated polymer and the polymer form the polymer binder via a complexation process and the polymer binder is electrically and ionically conductive.

Example 15: The cathode of example 14, wherein the first side chain is balanced with a first counterion, and the second side chain is balanced with a second counterion; the first and the second counterions are released during the complexation process such that the complexation process is thermodynamically favorable.

Example 16: The cathode of example 14 or 15, wherein the cathode is configured to be a portion of a lithium ion battery.

Example 17: The cathode of example 14, or 15, or 16, wherein the polymer binder is configured to form a slurry to coat the cathode and connect the cathode with a current collector.

Example 18: The cathode of any one of examples 14 to 17, wherein the active material is selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

Example 19: The cathode of any one of examples 14 to 18, wherein the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

Example 20: The cathode of any one of examples 14 to 19, wherein each of the conjugated polymer and the polymer is at least 50% charged.

Example 21: The cathode of any one of examples 14 to 20, wherein the polymer is a conjugated polymer or a non-conjugated polymer.

Example 22: The cathode of any one of examples 14 to 21, wherein the polymer is selected from the group consisting of: thiophene, propylenedioxythiophene, 3,4-ethylenedioxythiophene, bithiophene, P3HT-Im+, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

Example 23: The cathode of any one of examples 14 to 22, wherein the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

Example 24: The cathode of any one of examples 14 to 23, wherein the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate; wherein the second side chain has a positive charge and comprises a functional group selected from the group consisting of: an amine derivative, imidazolium, ammonium, trimethyl ammonium, triethyl ammonium, and pyridinium.

Example 25: The cathode of any one of examples 14 to 24, wherein the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im+) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

Example 26: The cathode of any one of examples 14 to 25, wherein the polymer binder does not dissolve in a polar electrolyte.

Example 27: The cathode of any one of examples 14 to 26, further comprising a conductive carbon additive material.

Example 28: A lithium ion battery, comprising: a cathode comprising: an active material; and a polymer binder comprising: a conjugated polymer; and a polymer; wherein the conjugated polymer is functionalized with at least a first side chain with a first electrical charge; wherein the polymer is functionalized with at least a second side chain with a second electrical charge that is opposite from the first electrical charge such that an electrostatic interaction is formed between the conjugated polymer and the polymer; and wherein the conjugated polymer and the polymer form the polymer binder via a complexation process and the polymer binder is electrically and ionically conductive; an anode; an electrolyte; and at least one current collector, wherein the polymer binder is configured to form a slurry to coat the cathode and connect the cathode with the at least one current collector.

Example 29: The lithium ion battery of example 28, wherein the first side chain is balanced with a first counterion, and the second side chain is balanced with a second counterion; the first and the second counterions are released during the complexation process such that the complexation process is thermodynamically favorable.

Example 30: The lithium ion battery of example 28 or 29, wherein the active material is selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

Example 31: The lithium ion battery of example 28, or 29, or 30, wherein the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

Example 32: The lithium ion battery of any one of examples 28 to 31, wherein each of the conjugated polymer and the polymer is at least 50% charged.

Example 33: The lithium ion battery of any one of examples 28 to 33, wherein the polymer is a conjugated polymer or a non-conjugated polymer.

Example 34: The lithium ion battery of any one of examples 28 to 33, wherein the polymer is selected from the group consisting of: thiophene, propylenedioxythiophene, 3,4-ethylenedioxythiophene, bithiophene, P3HT-Im+, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

Example 35: The lithium ion battery of any one of examples 28 to 34, wherein the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

Example 36: The lithium ion battery of any one of examples 28 to 35, wherein the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate, wherein the second side chain has a positive charge and comprises a functional group selected from the group consisting of: an amine derivative, imidazolium, ammonium, trimethyl ammonium, triethyl ammonium, and pyridinium.

Example 37: The lithium ion battery of any one of examples 28 to 36, wherein the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im+) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

Example 38: The lithium ion battery of any one of examples 28 to 37, wherein the polymer binder does not dissolve in a polar electrolyte.

Example 39: The lithium ion battery of any one of examples 28 to 38, wherein the cathode further comprises a conductive carbon additive material.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. For example, although certain structure heights/lengths are described, such structure dimensions are not required to practice the invention.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately,” “substantially,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A polymer binder comprising:
a conjugated polymer; and
a polymer;
wherein the conjugated polymer is functionalized with at least a first side chain with a first electrical charge;
wherein the polymer is functionalized with at least a second side chain with a second electrical charge that is opposite from the first electrical charge such that an electrostatic interaction is formed between the conjugated polymer and the polymer; and
wherein the conjugated polymer and the polymer form the polymer binder via a complexation process and the polymer binder is electrically and ionically conductive.

2. The polymer binder of claim 1, wherein the first side chain is balanced with a first counterion, and the second side chain is balanced with a second counterion; the first and the second counterions are released during the complexation process such that the complexation process is thermodynamically favorable.

3. The polymer binder of claim 1, wherein the polymer binder is configured to be a portion of a cathode of a lithium ion battery.

4. The polymer binder of claim 3, wherein the polymer binder is configured to form a slurry to coat the cathode and connect the cathode with a current collector.

5. The polymer binder of claim 3, wherein the cathode comprises an active material selected from the group consisting of: lithium cobalt oxide, lithium manganese oxide, lithium iron phosphate, lithium nickel manganese cobalt oxide, lithium ferro-phosphate, nickel manganese cobalt oxide, and nickel cobalt aluminum oxide.

6. The polymer binder of claim 1, wherein the conjugated polymer is selected from the group consisting of: thiophene, bithiophene, propylenedioxythiophene, 3,4-ethylenedioxythiophene, poly(3-(6′-(N-methylimidazolium) hexyl)thiophene (P3HT-Im+), poly[6-(thiophen-3-yl)hexane-1-sulfonate-co-3-(hexylthiophene)](P3HT-SO₃⁻-co-P3HT), and poly(3-(6′-(trimethylammonium)hexyl)thiophene (P3HT-TMA+).

7. The polymer binder of claim 1, wherein each of the conjugated polymer and the polymer is at least 50% charged.

8. The polymer binder of claim 1, wherein the polymer is a conjugated polymer or a non-conjugated polymer.

9. The polymer binder of claim 1, wherein the polymer is selected from the group consisting of: thiophene, propylenedioxythiophene, 3,4-ethylenedioxythiophene, bithiophene, P3HT-Im+, P3HT-SO₃⁻-co-P3HT, and P3HT-TMA+, acrylate, styrene, vinyl, siloxane, polystyrene sulfonate, and poly[(3-methyl-1-propylimidazolylacrylamide)-co-3-methyl-1-(propyl acrylamide)].

10. The polymer binder of claim 1, wherein the first side chain has a positive charge and comprises a functional group selected from the group consisting of: an amine derivative, imidazolium, ammonium, trimethyl ammonium, triethyl ammonium, and pyridinium; wherein the second side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate.

11. The polymer binder of claim 1, wherein the first side chain has a negative charge and comprises a functional group selected from the group consisting of: sulfate, sulfonate, sulfonyl((fluoro)sulfonyl)imide, sulfonyl((trifluoromethyl)sulfonyl)imide, sulfonyl((perfluorophenyl)sulfonyl)imide, bistriflimide, and phosphate; wherein the second side chain has a positive charge and comprises a functional group selected from the group consisting of: an amine derivative, imidazolium, ammonium, trimethyl ammonium, triethyl ammonium, and pyridinium.

12. The polymer binder of claim 1, wherein the polymer binder comprises a complex selected from the group consisting of: P3HT-Im+ complexed with polystyrene sulfonate (PSS⁻), poly(3-(hexylthiophene)-co-3-(6′-(N-methylimidazolium)hexyl)thiophene (P3HT-co-P3HT-Im+) complexed with PSS⁻, P3HT-TMA+ complexed with PSS⁻, poly[6-(thiophen-3-yl)hexane-1-sulfonate-co-3-(hexylthiophene)](PTHS:P3HT) complexed with poly[(3-methyl-1-propylimidazolylacrylamide)-co-3-methyl-1 (propyl acrylamide), and P3HT-SO₃⁻-co-P3HT complexed with poly[(3-methyl-1-propylimidazolylacrylamide)-co-3-methyl-1-(propylacrylamide)](imidazolium functionalized acrylate).

13. The polymer binder of claim 1, wherein the polymer binder does not dissolve in a polar electrolyte.

14.-39. (canceled)

40. The polymer binder of claim 3, wherein the cathode further comprises a conductive carbon additive material.

41. The polymer binder of claim 40, wherein the lithium ion battery further comprises an anode, an electrolyte, and at least one current collector, wherein the polymer binder is configured to form a slurry to coat the cathode and connect the cathode with the at least one current collector.
